(19) United States
(12) Patent Application Publication
(10) Pub. No.: US 2006/0051686 A1
(43) Pub. Date: Mar. 9, 2006

(54) Image structure, recording medium, image forming apparatus and post-process device

(75) Inventors: Osamu Ide, Kanagawa (JP); Shigeru Hayashi, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/066,973

(22) Filed: Feb. 28, 2005

(30) Foreign Application Priority Data
Sep. 7, 2004 (JP) P2004-259453

(51) Int. Cl. G03G 15/20

(52) U.S. Cl. 430/18; 430/137.1; 430/120; 430/111.4; 430/109.4; 430/124

(57) ABSTRACT

An image structure includes a normal toner image formed on an image support and comprising toner particles; and an adhesive toner image formed on or around the normal toner image, serving as a repeelable adhesive layer and comprising toner particles. The toner particles of the adhesive toner image have a glass transition point Tg in a range of from 30° C. to 50° C. and a melting point Tm in a range of from 70° C. to 110° C.

### BACKGROUND OF THE INVENTION

1. Field of the Invention

The present invention relates to an image structure constituted by toner images formed on an image support. Particularly, it relates to an image structure in which an adhesive toner image serving as a repeelable adhesive layer is formed in an arbitrary position on an image support having normal toner images formed thereon based on normal image information, a recording medium including the image structure, an image forming apparatus for forming the image structure and a post-process device for performing a post-process on the recording medium including the image structure.

2. Description of the Related Art

There are a large number of documents associated with personal privacy such as notices of use amount, bills, and receipts from public institutions such as local governments, the Social Insurance Agency, the National Tax Agency and the Waterworks Bureau or from quasi-public institutions such as Nippon Telegraph and Telephone Corporation, electric power companies and gas companies; payment notices, account balance notices and reminders from financial institutions such as banks, life insurance companies and stock companies; and grade transcripts and entrance examination notices from schools and so on. These documents have been heretofore sent as letters or postcards based on judgment of senders. When documents associated with privacy are mailed, in recent years, there are increasing cases for using letters in compliance with execution of the “Privacy Protection Law” from the viewpoint of privacy protection.

Letter can hide information and transmit a larger amount of information, compared with postcard. On the other hand, however, letter is higher in postage than postcard. For this reason, there is a problem that public or quasi-public institutions, financial institutions, school corporations, and so on, handling a large amount of privacy documents pay a large amount of postage. In order to solve the problem in postage, various postcard forms by which documents can be mailed as postcards and information can be hidden have been proposed. As one of the proposals, for example, there are an adhesive postcard folded into two through a transparent film (see JP-A-64-16691, JP-A-5-58083, JP-A-2003-96411), a repeelable pressure-sensitive adhesive postcard obtained by forming an adhesion-suppressing ink layer on a whole surface on an adhesive agent-containing layer except the whole or part of an edge portion and bonding the whole or part of the edge portion of the bonding portion more intensely than the non-edge portion (see JP-A-2-289393), a conceal label-containing postcard using a repeelable conceal label to hide information written on a postcard base material (see JP-A-5-131781), and so on.

When Patent Document 5 is taken as an example, the following method is known as a method for forming a document including such a repeelable adhesive layer.

The conceal label includes a surface base material, a polystyrene layer formed on one surface of the surface base material, a polyester film laminated on the polystyrene layer, and an adhesive layer applied on the surface of the polyester film. After a sheet of release paper is released, the conceal label is pasted on the surface of the postcard base material. When an upward stripping force is applied to the surface base material in order to release the conceal label, the polystyrene layer and polyester film between which bonding power is weak are released from each other so that the polyester film is left on the postcard base material. Thus, confidential information on the postcard base material and public information on the surface base material are prevented from being damaged.

An additional adhesion function member is essential to the repeelable adhesive postcard used heretofore. As the adhesion function member, a repeelable transparent film may be used, an adhesive agent-containing layer may be applied, or a conceal label may be pasted separately. Because of the adhesion function member, there is a technical problem that such an adhesive postcard costs a lot.

This type repeelable adhesive postcard (JP-A-64-16691, JP-A-5-58083, JP-A-2003-96411, JP-A-2-289393, JP-A-5-131781) is configured to have a repeelable adhesion function member provided on one surface of a postcard base material. For this reason, there is a technical problem that generation of a curl phenomenon which is often found in the case of a sheet-like material such as a sheet of paper and in which opposite ends are raised hinders efficiency of workability in a print process and a form process.

On this occasion, in order to prevent such a curl phenomenon, there is a postcard configured to have repeelable adhesion function members provided on opposite surfaces of a postcard base material. In an immoderate temperature or humidity condition, there is, however, possibility that a blocking phenomenon in which the front and rear surfaces of the postcard are bonded to each other after release of the adhesion function members occurs.

The repeelable adhesive postcard is aimed at hiding information written on the release surface. There are, however, some cases in which only the base material and the adhesive layer cannot exert sufficient conceal power. For compensation for this insufficiency, it is necessary to interpose an adhesive layer of an opaque sheet (see JP-UM-A-3-64770), or perform a tint block print process (see JP-UM-A-3-116974). This causes increase in cost of the adhesive postcard more and more.

In the case in which a large amount of highly confidential postcards are to be sent, the aforementioned conceal process, that is, a process of laminating conceal labels such as repeelably bonded resin films may be performed on the surfaces of documents produced by offset print etc. in a bulk handling manner. In the case in which a small amount of highly confidential postcards are to be sent, there is a technical problem that processing cost required for such an operation per sheet becomes very high.

For this reason, it is not economic to perform such a conceal process on personally made mails such as New Year cards, address change notices, or birthday postcards. On the other hand, a lot of personal information such as family photographs, names, addresses, phone numbers, or e-mail addresses is often written on such postcards. There is therefore a concern about leakage of the personal information when no conceal process is applied on the postcards at all.

With recent improvement in electrophotographic image quality and popularization of a digital camera and a film scanner, a photographic image which had been printed out as a silver salt photograph can be printed out by electrophotography. There are a report concerning small particle size toner aimed at achievement of image quality as high as that of a photograph (see JP-A-2002-255700 (Mode for Carrying Out the Invention)) and a report concerning an output technique with high glossness (see JP-A-2002-91220 and JP-A-2002-341619).

Generation of toner images by electrophotography has been made as follow.

That is, an illumination is applied to a document, and reflected light from the document is separated into colors by a color scanner so as to obtain digital camera image data. The image data is subjected to image processing and color corrosion by an image processing device so as to obtain image signals for a plurality of colors. These image signals are transformed into modulated laser light rays, for examples, by a semiconductor laser or the like in accordance with colors. By applying these laser light rays to an inorganic photoconductor or an organic photoconductor several times color by color, electrostatic latent images are formed. Examples of the inorganic photoconductor include Se and amorphous silicon. In the organic photoconductor, phthalocyanine pigment, bisazo pigment, or the like is used as a charge generating layer. Then, these electrostatic latent images are developed successively by charged toners of four colors, that is, yellow (Y), magenta (M), cyan (C), and black (B). The developed color toner images are transferred to an image support such as a sheet of paper or a film from the inorganic or organic photoconductor and fixed by a fixing device, for example, by a heating and pressing technique. Thus, a color image is formed on the image support.

In such an image generating technique, each of the color toners is formed by depositing fine particles (e.g. inorganic fine particles or resin fine particles) with an average particle size of about 5 mm to 100 mm on particles formed with an average particle size of 1 μm to 15 μm by dispersing a colorant to a bonding resin such as a polyester resin, a styrene/acrylic copolymer or a styrene/butadiene copolymer. Examples of the inorganic fine particles include silicon oxide, titanium oxide and alminium oxide. Examples of the resin fine particles include PMMA and PVDF. As for the colorant, for example, benzidine yellow, quinoline yellow and Hansa yellow can be used for the yellow (Y) colorant; rhodamine B, rose Bengal, and pigment red can be used for the magenta (M) colorant; phthalocyanine blue, aniline blue, and pigment blue can be used for the cyan (C) colorant; and carbon black, aniline black, and a blend of color pigments can be used for the black (K) colorant.

For example, a sheet of plain paper mainly containing a pulp material, a sheet of coat paper obtained by applying a mixture of a resin and white pigment etc. on a sheet of plain paper, and a white film obtained by mixing white pigment with a resin such as a polyester resin have been used as the image support. For examples, as described in Patent Document 10, for generation of an image as glossy as a silver halide photograph, it has been known that an image support obtained by forming a thermoplastic resin layer on a sheet of coat paper or a white film used as the base is preferably used.

For the technique used in the fixing process, there are known a heating and pressing fixation technique and a cooling and separating fixation technique. In the heating and pressing fixation technique, an image support on which color toner images have been transferred is passed between a pair of fixing rolls which are brought into pressure contact with each other and each of which includes a heat source such as an incandescent lamp, so that the color toners are melted by the heat and fixed on the image support. In the cooling and separating fixation technique, a fixing belt having a release layer of silicon etc. formed in its surface is laid on a plurality of stretching rolls, a pair of fixing rolls are disposed opposite to each other while the fixing belt is sandwiched between the fixing rolls, a heat source such as an incandescent lamp is included in each of the fixing rolls. In the condition that an image support on which color toner images have been transferred is superposed on the fixing belt, the image support is passed between the fixing rolls so that the toner images are fixed by heat and pressure, and the color toner images are separated from the fixing belt after the color toner images are cooled. Thus, the color toner images are fixed on the image support.

Particularly when an image as glossy as a silver halide photographic print is generated, it has been known that the latter fixation technique is preferably used. When the latter fixation technique is used in combination with an image support including the thermoplastic resin layer, uniform and high glossness regardless of image density can be obtained.

In recent years, glossy toner images can be produced easily by electrophotography as described above. There are increasing cases for mailing such type toner images in the form of postcards such as New Year cards.

In this case, it is preferable to hide information written in the toner images of the postcard. A conceal label etc. aimed at achievement of repeelable adhesion as described above need be bonded to the surface of the postcard base material. Such a work causes labor and time so that cost per sheet becomes very expensive. Therefore, as the real situation, information preferred to be hidden is not hidden but mailed directly.

### SUMMARY OF THE INVENTION

The present invention has been made in view of above circumstances and provides an image structure in which a repeelable adhesive layer is formed on a toner image surface in an inexpensive method without much time and labor for the purpose of hiding the toner image surface in which personal information such as a New Year card, an address change notice, a photograph, and so on, is printed, so that internal information can be hidden when the adhesive layer is bonded repeelably and the written information can be read when the adhesive layer is released in accordance with necessity, a recording medium including the image structure, an image forming apparatus for producing the image structure, and a post-process device for performing a post-process on the recording medium including the image structure.

According to a first aspect of the invention, an image structure includes a normal toner image formed on an image support and comprising toner particles; and an adhesive toner image formed on or around the normal toner image, serving as a repeelable adhesive layer and comprising toner particles. The toner particles of the adhesive toner image have a glass transition point Tg in a range of from 30° C. to 50° C. and a melting point Tm in a range of from 70° C. to 110° C.

According to a second aspect of the invention, A recording medium includes an image support; and an image structure. The image structure includes: a normal toner image formed on an image support and comprising toner particles; and an adhesive toner image formed on or around the normal toner image, serving as a repeelable adhesive layer and comprising toner particles. The toner particles of the adhesive toner image have a glass transition point Tg in a range of from 30° C. to 50° C. and a melting point Tm in a range of from 70° C. to 110° C.

According to a third aspect of the invention, an image forming apparatus for forming an image structure comprising a normal toner image formed on an image support and comprising toner particles; and an adhesive toner image formed on or around the normal toner image, serving as a repeelable adhesive layer and comprising toner particles, includes: a normal image generating unit for forming the normal toner image on the image support; and an adhesive image generating unit for forming an adhesive toner image on or around the normal toner image on the image support. The toner particles of the adhesive toner image have a glass transition point Tg in a range of from 30° C. to 50° C. and a melting point Tm in a range of from 70° C. to 110° C.

According to a fourth aspect of the invention, a post-process device includes: an adhesion device for bonding parts of a recording medium to each other repeelably through an adhesive toner image, the recording medium including an image structure formed on a image support and being folded while a normal toner image and an adhesive toner image constituting the image structure are on the inner side, the adhesion device includes a heating and conveyance member; and a pressing and conveyance member driving to rotate while being in contact with the heating and conveyance member and pressed by the heating conveyance member, the folded recording medium is conveyed by the heating conveyance member and the pressing and conveyance member while nipped.

### BRIEF DESCRIPTION OF THE DRAWINGS

FIG. 1A is an explanatory view showing an image structure and a recording medium according to the invention, and FIG. 1B is an explanatory view showing an image forming apparatus and a post-process device according to the invention.

FIG. 2A is an explanatory view showing an image structure obtained by Embodiment 1 of an image forming apparatus to which the invention has been applied, and FIG. 2B is an explanatory view of a section of the image structure.

FIG. 3 is an explanatory view showing an example of an instrument for measuring luminous reflectance which is an index of melting and mixing characteristic of an adhesive toner image used in Embodiment 1.

FIG. 4 is an explanatory view showing an overall configuration of the image forming apparatus according to Embodiment 1.

FIG. 5 is an explanatory view showing an image forming unit used in Embodiment 1.

FIG. 6 is an explanatory view showing details of a folding mechanism in a post-process unit used in Embodiment 1.

FIG. 7 is an explanatory view showing details of an adhesion device in the post-process unit used in Embodiment 1.

FIG. 8A is an explanatory view showing a control device used in Embodiment 1, and FIG. 8B is an explanatory view showing an example of an image generation mode selectable through an image generation operation panel.

FIG. 9A is an explanatory view showing an example of an image generation process of the image forming apparatus according to Embodiment 1, and FIG. 9B is an explanatory view showing an example of an image generation process of an image forming apparatus according to Embodiment 2.

FIG. 10 is an explanatory view showing a fixing process of the image forming apparatus according to Embodiment 1.

FIG. 11 is an explanatory view showing an adhesion process of the image forming apparatus according to Embodiment 1.

FIG. 12 is an explanatory view showing an image forming unit of the image forming apparatus according to Embodiment 2.

FIG. 13 is an explanatory view showing a fixing process of the image forming apparatus according to Embodiment 2.

FIG. 14 is an explanatory view showing an image forming apparatus according to Embodiment 3.

FIG. 15 is an explanatory view showing an image forming apparatus according to Embodiment 4.

FIG. 16 is an explanatory view showing an image generation condition setting process of the image forming apparatus according to Embodiment 4.

FIG. 17 is an explanatory view showing a table of characteristics of crystalline polyester resins A to L used in Examples.

FIG. 18 is an explanatory view showing a table of characteristics of amorphous resins M to Q used in Examples.

FIG. 19 is an explanatory view showing a table of characteristics of color toner agents a to c used in Examples.

FIG. 20 is an explanatory view showing a table of Examples 1 to 7.

FIG. 21 is an explanatory view showing a table of Comparative Examples 1 to 9.

FIG. 22 is an explanatory view showing a table of evaluation results of Examples 1 to 7 and Comparative Examples 1 to 9.

### DETAILED DESCRIPTION OF THE PREFFERED EMBODIMENTS

While the invention has been described in detail and with reference to specific embodiments thereof, it will be apparent to one skilled in the art that various changes and modifications can be made without departing from the scope thereof.

This application is based on Japanese patent application No. 2004-259543 filed on Sep. 7, 2004, the entire contents thereof being hereby incorporated by reference.

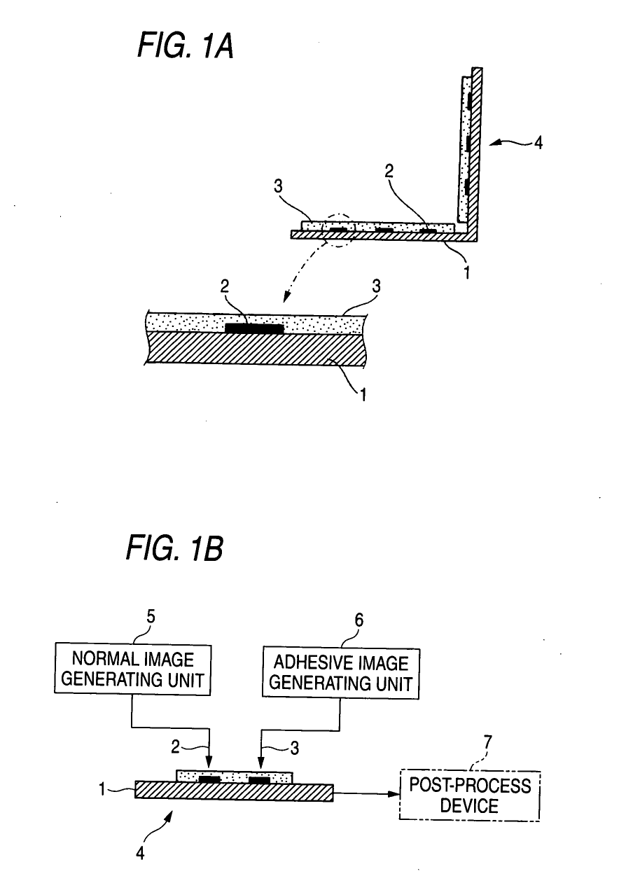

As shown in FIG. 1A, the invention provides an image structure comprising: normal toner images 2 formed on an image support 1; and an adhesive toner image 3 formed on or around the normal toner images 2 and serving as a repeelable adhesive layer; wherein: toner particles forming the adhesive toner image 3 have a glass transition point Tg in the range of from 30° C. to 50° C. and a melting point Tm in the range of from 70° C. to 110° C.

In such a technical method, the normal toner images 2 formed on the image support 1 are not limited to electrophotographic images (images formed by electrophotography). For example, the normal toner images may include electrostatically recorded images (images formed by an electrostatic recording technique) as long as the images use general toners (toners such as polyester based toners, or styrene based acrylic toners).

Any adhesive toner image may be used as the adhesive toner image 3, if the adhesive toner image forms a repeelable adhesive layer. The adhesive toner image may be laminated wholly or partially on the normal toner images 2 or may be not laminated on the normal toner images 2 but laminated directly on the image support 1. In any case, parts of the adhesive toner image 3 need be bonded to each other when, for example, the image support 1 is folded into parts, or parts of the image support 1 are superposed on each other.

For example, after such an image structure is folded into two while the adhesive layer is located on the inner side, the folded two of the image structure can be bonded to each other by a heating and pressing process at a temperature higher by about 10° C. to 20° C. than Tg. Because the temperature is not higher than the melting point, the parts of the adhesive layer are not mixed with each other so that there is no fear that the parts of the adhesive layer can not be released from each other.

If Tg is lower than 30° C., a problem such as blocking may be caused when the image structure before folding is laminated to a rear surface and stored. If Tg is higher than 50° C., a component forming the melting point will act in the adhesion process so that the parts of the adhesive layer cannot be released from each other.

If Tm is lower than 70° C., a component forming the melting point will act in the adhesion process so that the parts of the adhesive layer cannot be released from each other. If Tm is higher than 110° C., low temperature fixation cannot be performed and a high quality image in terms of graininess, resolution, etc. cannot be obtained because toner images are disordered due to excessive melting of the resin forming the toner images in the fixing process.

In the image structure, a thermoplastic resin of the toner particles forming the adhesive toner image 3 has an endotherm Qg based on the glass transition point Tg in the range of from 30° C. to 50° C. and an endotherm Qm based on the melting point Tm in the range of from 70° C. to 110° C. in accordance with differential thermogravimetric analysis, and Qg and Qm satisfy the relation 0.1<Qg/Qm<0.4.

The image structure can be released stably even when the adhesion condition somewhat varies.

That is, when Qg/Qm is not larger than 0.1, good adhesion cannot be obtained stably. When Qg/Qm is not smaller than 0.4, good releasability cannot be obtained stably. If the relation 0.1<Qg/Qm<0.4 holds, release can be performed stably.

In this type image structure, preferably, a thermoplastic resin of the toner particles forming the adhesive toner image 3 at least contains a crystalline polyester resin and an amorphous resin, and the glass transition point Tg is lower by at least 10° C. than a glass transition point Tg′ of the amorphous resin alone.

The image structure can be bonded well and released with any defect in the surface.

If the thermoplastic resin of the toner particles (hereinafter referred to as adhesive toner particles in accordance with necessity) forming the adhesive toner image on this occasion is made of a crystalline polyester resin and an amorphous resin, the mechanical strength can be improved while the melting temperature can be reduced to some extent, so that blocking at low temperature can be prevented. Therefore, the following situation can be avoided. That is, the image structures each having the adhesive toner image 3 formed on the image support 1 can be prevented from being stuck to one another when the image structures are laminated on one another and stored in a high temperature environment such as a warehouse, a car, and so on. Incidentally, one kind of crystalline polyester resin may be used or a mixture of different kinds of crystalline polyester resins may be used. One kind of amorphous resin may be used or a mixture of different kinds of amorphous resins may be used.

The temperature condition set as described above is based on the following the reason. That is, when Tg is higher than Tg′−10° C., the crystalline polyester resin component forming the melting point and the amorphous resin component forming the Tg are not mixed uniformly, so that the amorphous resin component may be combined at the time of adhesion to thereby result in a defect in the surface during release.

In the thermoplastic resin structure of the adhesive toner particles, preferably, a weight ratio of the crystalline polyester resin to the amorphous resin is in the range of 35:65 to 65:35.

When the crystalline polyester resin is smaller than 35%, a surface defect may be caused during release. On the other hand, when the crystalline polyester resin is larger than 65%, adhesion will be lowered.

Further, In the thermoplastic resin structure of the adhesive toner particles, in order to make use of characteristics of the two resins and perform adhesion and release stably, preferably, the thermoplastic resin of the adhesive toner particles is a resin obtained by melting and mixing the crystalline polyester resin and the amorphous resin.

Further, the following resin melting and mixing conditions are preferable.

As conditions for melting and mixing the crystalline polyester resin and the amorphous resin, preferably, T (° C.) is selected to be in a range of from T₀ to T₀+20, and t (minutes) is selected to be in a range of t₀ to 10×t₀ in which T₀ (° C.) is the temperature at which the luminous reflectance Y of a 20 μm-thick film is 1.5% when the film is formed from a polyester resin obtained by melting and mixing the crystalline polyester resin and the amorphous resin for time t₀ (minutes), T (° C.) is the temperature at which the crystalline polyester resin and the amorphous resin are melted and mixed, and t (minutes) is the time during which the crystalline polyester resin and the amorphous resin are melted and mixed.

According to such melting and mixing conditions, adhesion and release can be performed stably.

The luminous reflectance Y is a ratio of luminous flux reflected from a substance surface to luminous flux incident on the substance surface. Because the resin is not melted and mixed well when the luminous flux Y is larger than 1.5, mechanical strength etc. is lowered. Accordingly, the crystalline polyester resin and the amorphous resin are configured to be melted and mixed in the condition of the luminous reflectance Y set at 1.5% (preferable temperature and time conditions during melting and mixing).

Such melting and mixing conditions are selected based on the following reason. That is, when T is smaller than T₀° C. or t is smaller than t₀, the resins cannot be mixed with each other sufficiently so that there is possibility that a surface defect may be caused during release. On the other hand, when T is larger than T₀+20° C., or t is larger than 10×t₀, there is possibility that blocking is caused easily due to plasticization of the resins so that release cannot be performed.

As a preferred form of the adhesive toner particles, the toner particles are produced by coagulating and coalescing two kinds of emulsion particles based on an emulsion fluid of the crystalline polyester resin and an emulsion fluid of the amorphous resin. According to the form, the image formed by the toner particles has a moderate dispersion degree of the two components and can be bonded and released stably.

As a preferred form of the adhesive toner particles, the toner particles contain 5 wt % to 30 wt % of inorganic or organic fine particles. The image structure can be bonded and released stably, and solidification speed in the fixing process is so fast that it is possible to avoid a problem that an image before adhesion is blocked.

As preferred viscosity conditions for the toner particles (hereinafter referred to as normal toner particles in accordance with necessity) forming each of the normal toner images, the adhesive toner particles and the image support 1, the normal toner particles have viscosity not smaller than 10³ Pa·s and not larger than 10⁴ Pa·s in a fixing temperature, the adhesive toner particles have viscosity not smaller than 10³ Pa·s in the fixing temperature, and a thermoplastic resin of a light scattering layer included in the image support has viscosity not smaller than 10⁴ Pa·s in the fixing temperature, the light scattering layer at least containing white pigment and the thermoplastic resin.

Disordering of the toner images of the image structure in the fixing process is small so that an image high in whiteness and resolution can be obtained.

When the viscosity of the normal toner particles in the fixing temperature is small than 10³ Pa·s, the toner particles are melted excessively and graininess and resolution are lowered. On the other hand, when the viscosity of the normal toner particles in the fixing temperature is larger than 10⁴ Pa·s, strength of the toner image portion is insufficient so that defective toner images may be caused during release.

When the viscosity of the adhesive toner particles in the fixing temperature is larger than 10³ Pa·s, there is possibility that the toner images are disordered largely so that high image quality cannot be obtained.

When the viscosity of the thermoplastic resin of the light scattering layer in the image support 1 is small than 10⁴ Pa·s, there is possibility that the layer is melted excessively so that Brewster's interference is generated.

As a preferred form of the amorphous resin for the adhesive toner particles, for example, the amorphous resin may contain at least 80 wt % of a copolymer between a styrene based resin and an acrylic based resin.

The image structure is preferable in that the charging characteristic of the adhesive toner particles is excellent so that the adhesive layer can be formed with a uniform thickness and strength is high.

As another preferred form of the amorphous resin for the adhesive toner particles, for example, the amorphous resin contains at least 80 wt % of a polyester based resin.

The image structure is preferable in that the dispersion unit of the adhesive toner particles forming the adhesive layer is moderate and an adhesive layer repeelable stably can be provided.

As a further preferred form of this type adhesive toner particles, for example, the crystalline polyester resin and the amorphous polyester resin contain a common alcohol-derived or acid-derived component.

The image structure is preferable in that the dispersion unit of the adhesive toner particles forming the adhesive layer is moderate and an adhesive layer repeelable stably can be provided.

As a preferred form of the adhesive toner particles (in which the crystalline polyester resin and the amorphous polyester resin contain a common alcohol-derived or acid-derived component), for example, the alcohol-derived component of the amorphous polyester resin contains a straight-chain aliphatic component the same as a straight-chain aliphatic component which has six carbon atoms to twelve carbon atoms and which is a main component of the alcohol-derived component of the crystalline polyester resin, and the straight-chain aliphatic component of the amorphous polyester resin relative to the whole alcohol-derived component of the amorphous polyester resin is in the range of from 10 mol % to 30 mol %; and the acid-derived component of the amorphous polyester resin contains an aromatic component the same as an aromatic component based on terephthalic acid, isophthalic acid or naphthalene dicarboxylic acid, and the aromatic component of the amorphous polyester resin relative to the whole acid-derived component of the amorphous polyester resin is not smaller than 90 mol %.

The image structure is preferable in that the dispersion unit of the adhesive toner particles forming the adhesive layer is further moderate, an adhesive layer repeelable stably can be provided and low temperature fixation can be attained.

When the straight-chain aliphatic component of the amorphous polyester resin is smaller than 10 mol %, the fixing temperature is high and adhesion is somewhat low. When the straight-chain aliphatic component of the amorphous polyester resin is larger than 30 mol %, releasability is somewhat deteriorated. When the aromatic component of the amorphous polyester resin is smaller than 90 mol %, the dispersion unit of the two resin is large and releasability is somewhat deteriorated.

As another preferred form of the adhesive toner particles, for example, the alcohol-derived component of the crystalline polyester resin contains a straight-chain aliphatic component with six carbon atoms to twelve carbon atoms and an aromatic based diol-derived component, the straight-chain aliphatic component of the crystalline polyester resin relative to the whole alcohol-derived component of the crystalline polyester resin is in the range of from 85 mol % to 98 mol %, and the aromatic based diol-derived component of the crystalline polyester resin relative to the whole alcohol-derived component of the crystalline polyester resin is in the range of from 2 mol % to 15 mol %; and the alcohol-derived component of the amorphous polyester resin contains a straight-chain aliphatic component and an aromatic based diol-derived component the same as main components of the alcohol-derived component of the crystalline polyester resin, the straight-chain aliphatic component of the amorphous polyester resin relative to the whole alcohol-derived component of the amorphous polyester resin is in the range of from 10 mol % to 30 mol %, and the aromatic based diol-derived component of the amorphous polyester resin relative to the whole alcohol-derived component of the amorphous polyester resin is in the range of from 70 mol % to 90 mol %.

The image structure is preferable in that the dispersion unit of the adhesive toner particles forming the adhesive layer is further moderate, an adhesive layer repeelable stably can be provided and low temperature fixation can be attained.

When the straight-chain aliphatic component of the alcohol-derived component of the crystalline polyester resin is smaller than 85 mol %, the dispersion unit is small and releasability is somewhat deteriorated. When the straight-chain aliphatic component of the alcohol-derived component of the crystalline polyester resin is larger than 98 mol %, mixing characteristic is lowered, the dispersion unit is large and releasability is somewhat deteriorated.

When the aromatic based diol-derived component is less than 2 mol %, mixing characteristics is lowered, the dispersion unit is large and releaseability is somewhat deteriorated. When the aromatic based diol-derived component exceeds 15 mol %, the dispersion unit become small and releasability is somewhat deteriorated.

Further, in the condition that the amorphous polyester resin contains the same component as the main component of the alcohol-derived component of the crystalline polyester resin, when the straight-chain aliphatic component of the amorphous polyester resin is smaller than 10 mol %, the fixing temperature is high and adhesion is somewhat lowered. On the other hand, when the straight-chain aliphatic component of the amorphous polyester resin is larger than 30 mol %, releasability is somewhat deteriorated. When the aromatic diol component of the amorphous polyester resin is smaller than 70 mol %, releasability is deteriorated. When the aromatic diol component of the amorphous polyester resin is larger than 90 mol %, the fixing temperature is increased and adhesion is low, unpreferably.

As preferred molecular weight conditions of the thermoplastic resin of the adhesive toner particles, for example, the weight average molecular weight of the crystalline polyester resin is in the range of from 17000 to 30000, and the weight average molecular weight of the amorphous polyester resin is in the range of from 8000 to 30000.

When the molecular weight of each of the resins is smaller than the lower limit, strength of the adhesive layer is somewhat low so that there is possibility that a surface defect is caused during release. On the other hand, when the molecular weight of each of the resins is larger than the upper limit, there is possibility that low temperature fixability is somewhat deteriorated.

Although the invention is aimed at the image structure per se, it is not limited thereto. The invention is also aimed at a recording medium 4 including the predetermined image structure (constituted by the normal images 2 and the adhesive toner image 3).

Any recording medium may be used as the recording medium 4 as long as the recording medium includes the normal toner images 2 and the adhesive toner image 3. The recording medium may be a recording medium at a stage before the adhesive toner image 3 is used as a repeelable adhesive layer. It is a matter of course that the recording medium 4 may be a recording medium at a stage after the adhesive toner image 3 is used as a repeelable adhesive layer.

As a representative form of the recording medium 4 at a stage after the adhesive toner image 3 is used as a repeelable adhesive layer, for example, there is a form in which the image support 1 is folded repeelably through the adhesive layer 3. As another form, there is a form in which two image supports 1 are bonded to each other through the adhesive toner image 3.

The invention is aimed at an image forming apparatus for producing the image structure.

In this case, according to the invention, for example, as shown in FIG. 1B, an image forming apparatus for forming a predetermined image structure (constituted by normal toner images 2 and an adhesive toner image 3) on an image support 1 includes a normal image generating unit 5 and an adhesive image generating unit 6. The normal image generating unit 5 forms the normal toner images 2 on the image support 1. The adhesive image generating unit 6 forms the adhesive image 3 on or around the normal images 2 on the image support 1.

In this configuration, although the normal image generating unit 5 and the adhesive image generating unit 6 may be provided separately and individually, it is preferable that a unit partially serving as the normal image generating unit 5 and the adhesive image generating unit 6 is used, in order to simplify the configuration of the apparatus.

As a representative form of the normal image generating unit 5 and the adhesive image generating unit 6 in the image forming apparatus, for example, the normal image generating unit 5 and the adhesive image generating unit 6 may be provided with at least a fixing device for fixing the normal toner images 2 and the adhesive toner image 3 on the image support 1.

In this configuration, as a preferred form of the fixing device, for example, the fixing device includes a fixing member, a heating and pressing unit and a cooling and separating unit. The fixing member is brought into close contact with the images on the image support while the images on the image support are nipped. The heating and pressing unit heats and presses the normal toner images 2 and the adhesive toner image 3 on the image support 1. The cooling and separating unit cools the heated and pressed normal toner images 2 and adhesive toner image 3 and separates the normal toner images 2 and the adhesive toner image 3 from the fixing member.

According to the configuration, when cooling and separation are performed after the heating and pressing process, the surface characteristic of the fixing member is transferred directly to the image surface portion on the image support 1. Thus, if the surface characteristic of the fixing member is good, an excellent image structure can be obtained.

In this type image forming apparatus, as a representative form of the adhesive image generating unit 6, for example, the adhesive toner image 3 is led to the fixing device after transferred to the image support 1.

In this case, the adhesive toner image 3 is formed on the image support 1 in a stage before the fixing device, and then subjected to a fixing process by the fixing device. In the fixing process performed by the fixing device, the adhesive layer is smooth and good adhesion can be attained at the time of adhesion.

Further, as another representative form of the adhesive image generating unit 6, for example, the adhesive image generating unit forms the adhesive toner image 3 on the fixing member of the fixing device, and fixes the normal toner images 3 and the adhesive toner image 3 on the image support 1 in a fixing and nip region of the fixing device.

In this case, the adhesive toner image 3 is formed on the fixing member of the fixing device, and subjected to a fixing process in the fixing and nip region. Because it is not necessary to electrostatically transfer the adhesive toner image 3 serving as an adhesive layer on or around the unfixed normal toner images 2, the adhesive layer can be formed while the normal toner images 2 are not disordered.

As shown in FIG. 1B, the invention is also aimed at a post-process device 7 performing a predetermined post-process on the recoding medium 4 in which the image structure is formed.

In this case, for example, the post-process device 7 according to the invention may include an adhesion device for bonding parts of the recording medium 4 (see FIG. 1A) to each other repeelably through the adhesive toner image 3. The recording medium 4 in which the predetermined image structure (constituted by the normal toner images 2 and the adhesive toner image 3) is formed on the image support 1 is folded while the normal toner images 2 and the adhesive toner image 3 are on the inner side. The adhesion device includes a heating and conveyance member and a pressing and conveyance member driving to rotate while being in contact with the heating and conveyance member and pressed by the heating conveyance member. The folded recording medium 4 is conveyed by the two conveyance members while nipped. A temperature of the adhesive toner image 3 during nip and conveyance of the recording medium 4 is not lower than the glass transition point Tg+20° C. and not higher than the melting point Tm−10° C.

As the post-process device 7, an adhesion device may be provided and a folding mechanism is not provided particularly. The post-process device 7 performs a post-process on a recording medium folded manually or by another device.

As a temperature condition of the adhesion device, it is necessary that the temperature of the adhesive toner image 3 during nip and conveyance of the recording medium 4 is in the range of from the glass transition point Tg+10° C. to Tg+20° C. and not higher than the melting point Tm−10° C.

In this case, adhesion can be achieved by performing a heating and pressing process at a temperature higher by about 10° C. to 20° C. than Tg. Because the temperature is not higher than the melting point, parts of the adhesive layer are prevented from being mixed each other so that the parts of the adhesive layer can be released.

As a representative form of this type post-process device 7, a post-process device includes: a folding mechanism and an adhesion device. The folding mechanism folds the recording medium 4 including the predetermined image structure formed on the image support 1 while the normal toner images 2 and the adhesive toner image 3 are on the inner side. The adhesion device bonds the folded recording medium 4 by the folding mechanism repeelably through the adhesive toner image 3.

The image forming apparatus according to the invention may further comprise the post-process device 7.

According to the configuration, the image forming apparatus can perform “image formation+prost-process (folding and adhesion process)” in a series of steps.

In the mode in which the post-process device 7 is incorporated in the image forming apparatus and the normal image generating unit 5 and the adhesive image generating unit 6 are provided with at least a fixing device for fixing the normal toner images 2 and the adhesive toner 3 image on the image support 1 for the purpose of simplification of the apparatus configuration, preferably, the fixing device also serves as an adhesion device.

In the mode, the heating condition may be changed in accordance with fixing and adhesion.

In the image structure according to the invention, an adhesive toner image other than normal toner images is formed on an image support, a glass transition point and a melting point of toner particles forming the adhesive toner image are optimized, and the adhesive toner image serves as a repeelable adhesive layer. Thus, the repeelable adhesive layer can be formed easily on the image support without use of an additional adhesion function member such as a conceal label etc. so that a recording medium in which information of the normal toner images is hidden can be produced easily.

Further, according to this type recording medium, the information formed by the normal toner images on the image support can be hidden and the adhesive layer made of the adhesive toner image can be released if necessary, so that information written on the image support can be read. Accordingly, secret information such as personal information can be transmitted surely only to a specific user in an inexpensive structure while leakage of the secret information such as personal information can be avoided surely.

According to the image forming apparatus for producing this type image structure, an adhesive toner image serving as a repeelable adhesive layer can be formed outside normal toner images and on an image support. Accordingly, a recording medium by which secret information such as personal information can be hidden can be obtained inexpensively, easily and with small energy consumption.

Further, according to the post-process device for performing a predetermined post-process on this type recording medium, for example, an image support is folded into parts so that the parts of the image support are bonded to each other through a repeelable adhesive toner image. Accordingly, a recording medium in the state that information of normal toner images on the image support is hidden can be obtained inexpensively, easily and with small energy consumption.

The invention will be described below in detail based on embodiments shown in the accompanying drawings.

### Embodiment 1

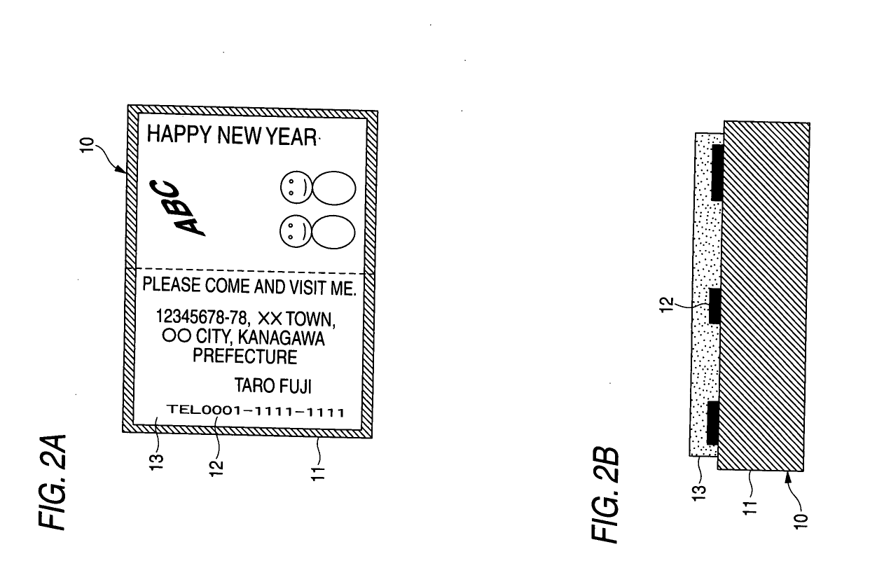

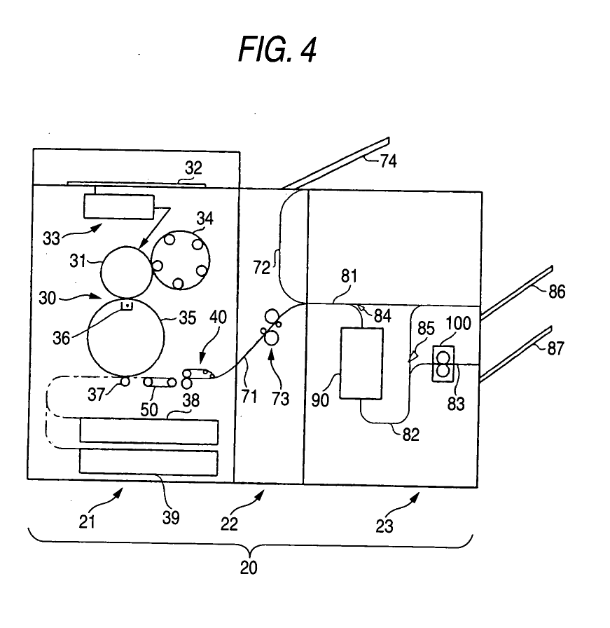

FIG. 2A shows an image structure obtained by Embodiment 1 (see FIG. 4 et seq.) of an image forming apparatus to which the invention is applied. FIG. 2B is an explanatory view of a section of the image structure.

In this embodiment, as shown in FIGS. 2A and 2B, a color toner image (normally equivalent to a toner image) 12 and an adhesive toner image 13 are formed on an image support 11. The color toner image 12 is generally composed of normal color component toners, such as color component toners of yellow, magenta, cyan and black. The adhesive toner image 13 is formed on or around the color toner image 12 (on the whole region of the image support 11 except its edge portion in this embodiment) and serves as a repeelable adhesive layer. Thus, a recording medium 10 having information recorded thereon is formed.

Here, the color toner image 12 is generated to express various kinds of information (such as text, name, address, phone number, etc.) concerning a New Year card, a personal information notice or the like. On the other hand, the adhesive toner image 13 bonds the image support 11 repeelably and conceals various kinds of information based on the color toner image 12 on the image support 11 when, for example, the image support 11 is folded along the dot line shown in FIG. 2A. When the adhesive layer is released again in accordance with necessity, the image support 11 is restored from a folded state to an unfolded state so that the various kinds of information on the image support 11 can be viewed.

Image Support

In this embodiment, though the image support 11 may be, for example, a sheet of base paper, that is, a sheet of plain paper, the image support 11 is preferably a sheet of resin coat paper prepared by forming a light scattering layer on a sheet of base paper. The light scattering layer is made of a resin containing 10 wt % to 50 wt % of white pigment dispersed therein. Alternatively, the light scattering layer may be a plastic film prepared by dispersing 20 wt % to 40 wt % of white pigment in a thermoplastic resin such as PET.

Here, the base paper may be selected from materials generally used in printing paper or electrophotographic paper. That is, natural pulp or synthetic pulp selected from needle-leaved trees and broad-leaved trees is used as a main material of the base paper. If necessary, a filler such as clay, talc, calcium carbonate or urea resin particles, a sizing agent such as rosin, alkylketene dimer, higher fatty acid, epoxidized fatty amide, paraffin wax or alkenyl succinic acid, a paper strength agent such as starch, polyamide-polyamine pichlorohydrin or polyacrylamide, a fixing agent such as aluminum sulfate or cationic polymer, and so on, may be added to the main material.

In order to give smoothness and flatness to the base paper, the base paper is preferably subjected to surface treatment by application of heat and pressure by an apparatus such as a machine calendar or a super calendar.

Fine particles of known white pigments such as titanium oxide, calcium carbonate and barium sulfate may be used as the white pigment contained in the light scattering layer. In order to increase whiteness, it is preferable that titanium oxide is used as a main component of the white pigment.

A thermoplastic resin such as polyolefin or polyolefin copolymer used in a photographic support or a known resin such as butadiene rubber used in a printing support may be used as the resin contained in the light scattering layer. To generate a photographic image, polyolefin or a polyolefin copolymer is preferably used. For example, low-density polyethylene, high-density polyethylene, polypropylene, ethylene-acrylic acid copolymer, ethylene-acrylic ester copolymer or ethylene-polyvinyl acetate copolymer can be preferably used.

Further, it is preferable that a fluorescent whitening agent is added to the light scattering layer so that the fluorescent whitening agent can absorb ultraviolet rays and generate fluorescence. The image support 11 formed thus can provide an image high in whiteness and vivid in color brightness.

Color Toner

In this embodiment, yellow toner, magenta toner, cyan toner, black toner, and so on, each of which is made of electrically insulating particles at least containing a thermoplastic binder resin and a colorant may be used as the toners for generating the color toner images 12.

The binder resin may be selected suitably in accordance with purpose. Examples of the binder resin include: known resins used in general toner, such as polyester based resins, polystyrene based resins, polyacrylic based resins, other vinyl based resins, polycarbonate based resins, polyamide based resins, polyimide based resins, epoxy based resins, and polyurea based resins; and copolymers of the known resins. Especially, a polyester resin or a resin of a styrene-acrylic copolymer is preferred in order to satisfy toner characteristics such as low temperature fixability, fixing strength and keeping quality.

Further, it is preferable that the weight average molecular weight of the binder resin is not smaller than 5000 and not larger than 40000, and that the glass transition point of the binder resin is not lower than 50° C. but lower than 75° C.

Coloring materials generally used for generation of a color image can be used as the colorants.

Although either dye type colorant or pigment type colorant can be used as each colorant, a pigment type colorant is preferred from the viewpoint of resistance to light. For example, benzidine yellow, quinoline yellow or Hansa yellow may be used for the yellow (Y) colorant. Rhodamine B, rose Bengal or pigment red may be used for the magenta (M) colorant. Phthalocyanine blue, aniline blue or pigment blue may be used for the cyan (C) colorant. Carbon black, aniline black or a blend of color pigments may be used for the black (K) colorant.

It is important that irregular reflection in an interface between the pigment of each colorant and the binder is suppressed favorably for the purpose of widening the region of color reproduction. For example, it is effective to combine the binder with a colorant containing small particles of a pigment densely dispersed therein as disclosed in JP-A-4-242752.

Because different kinds of coloring materials have different spectral absorption characteristics or different emission colors, the optimal amount of the coloring material in each toner also varies. The amount of the coloring material normally ranges from about 3 wt % to about 10 wt %. It is preferable that the amount of the coloring material is selected suitably in consideration of the region of color reproduction.

It is preferable that wax is added to each color toner.

There is no particular limitation on the composition of the wax as long as the wax does not spoil the effect of the embodiment. The wax may be suitably selected from known materials used as wax, in accordance with the purpose. Examples of the material of the wax include a polyethylene based resin, and carnauba natural wax. In this embodiment, it is preferable that the amount of wax having a melting point ranging from 80° C. to 100° C. is not smaller than 2 wt % but smaller than 8 wt %.

Although the particle size of each color toner need not to be particularly limited, it is preferable that the particle size of the color toner is not smaller than 4 μm and not larger than 8 μm in order to obtain an image with good graininess and gradation.

To obtain an image with good graininess and gradation, it is necessary to control fluidity and static electrification of the toner. From this viewpoint, it is preferable that inorganic fine particles and/or organic fine particles are externally added or deposited on the surface of the color toner.

The inorganic fine particles are not particularly limited as long as the inorganic fine particles do not spoil the effect of the embodiment. The inorganic fine particles may be suitably selected from known fine particles used as external additives, in accordance with the purpose. Examples of the material of the inorganic fine particles include silica, titanium dioxide, tin oxide, and molybdenum oxide. In consideration of stability of static electrification, etc., the inorganic fine particles may be subjected to hydrophobic treatment with a silica coupling agent, a titanium coupling agent or the like.

The organic fine particles are not particularly limited as long as the organic fine particles do not spoil the effect of the embodiment. The organic fine particles may be suitably selected from known fine particles used as external additives, in accordance with the purpose. Examples of the material of the organic fine particles include a polyester based resin, a polystyrene based resin, a polyacrylic based resin, a vinyl based resin, a polycarbonate based resin, a polyamide based resin, a polyimide based resin, an epoxy based resin, a polyurea based resin, and a fluoro-based resin.

Especially preferably, the mean particle size of the inorganic fine particles and the organic fine particles is in a range of from 0.005 μm to 1 μm. If the mean particle size is smaller than 0.005 μm, it may be impossible to obtain a desired effect because coagulation occurs when the inorganic fine particles and/or organic fine particles are deposited on the surface of the toner. On the other hand, if the mean particle size is larger than 1 μm, it is difficult to obtain a higher quality image.

Preferably, the toner particles for forming the color toner image 12 have a viscosity not lower than 10³ Pa·s and not higher than 10⁴ Pa·s at a fixing temperature.

The toner particles for forming the color toner image 12 may be combined with a known carrier selected suitably in order to prepare a two-component developer. Or the toner particles may be used as a one-component developer so that the toner particles can develop an electrostatic latent image when electrostatically charged due to friction with a developing sleeve or an electrifying member.

Adhesive Toner

Particles of toner (hereinafter also referred to as “adhesive toner” if necessary) for forming the adhesive toner image 13 serving as a repeelable adhesive layer need contain at least a thermoplastic resin.

In this embodiment, the thermoplastic resin preferably contains two kinds of resins, that is, a crystalline polyester resin and an amorphous resin. Although only one crystalline polyester resin may be used, a mixture of different crystalline polyester resins may be used. Although only one amorphous resin may be used, a mixture of different amorphous resins may be used.

In this embodiment, the adhesive toner particles need have a glass transition point Tg in a range of from 30° C. to 50° C., and a melting point Tm in a range of from 70° C. to 110° C.

The adhesive toner particles have an endotherm Qg based on the glass transition point Tg in the range of from 30° C. to 50° C. and an endotherm Qm based on the melting point Tm in the range of from 70° C. to 110° C. Preferably, the endotherms Qg and Qm satisfy the relation 0.1<Qg/Qm<0.4.

The adhesive toner particles are preferably provided so that the glass transition point Tg of the thermoplastic resin is lower by at least 10° C. than the glass transition point Tg′ of the amorphous resin alone.

Preferably, the viscosity of the adhesive toner particles at a fixing temperature is not higher than 10³ Pa·s.

In the thermoplastic resin of the adhesive toner particles, the weight ratio of the crystalline polyester resin to the amorphous resin is preferably in a range of from 35:65 to 65:35. If the ratio of the weight of the amorphous resin to the total weight of the thermoplastic resin is lower than 35%, there is a possibility that heat resistance is deteriorated. If the ratio of the weight of the amorphous resin to the total weight of the thermoplastic resin is higher than 65%, mechanical strength is lowered and melting and mixing property is lowered when the two resins are melted and mixed. Accordingly, because it is necessary to elongate the melting time, heat resistance is lowered as well as production efficiency is lowered.

Let T₀ (° C.) be the temperature at which the luminous reflectance Y of a 20 μm-thick film is 1.5% when the film is formed from a polyester based resin obtained by melting and mixing the crystalline polyester resin and the amorphous resin for time t₀ (minutes). Let T (° C.) be the temperature at which the crystalline polyester resin and the amorphous resin are melted and mixed. Let t (minutes) be the time during which the crystalline polyester resin and the amorphous resin are melted and mixed. It is preferable that T is selected to be in a range of from T₀ (° C.) to T₀ (° C.)+20 (° C.), and that t is selected to be in a range of to (minutes) to 10×t₀ (minutes). If T is smaller than T₀ or t is smaller than t₀, there is a possibility that mechanical strength will be lowered and heat resistance will be deteriorated due to insufficient mixing characteristic. If T is larger than T₀+20 or t is larger than 10×t₀, there is a possibility that heat resistance will be deteriorated due to reduction in density of the resin.

From the viewpoints of heat resistance and mechanical strength, it is more preferable that T may be selected to be in a range of from T₀+5 (° C.) to T₀+10 (° C.), and that t may be selected to be in a range of from to (minutes) to 3×t₀ (minutes).

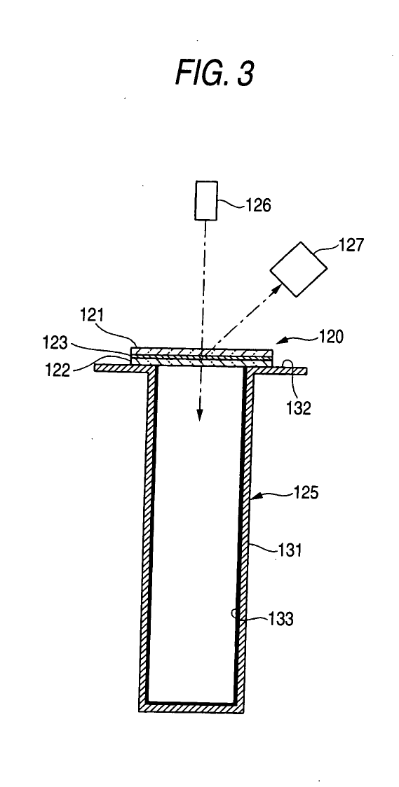

In this embodiment, the luminous reflectance Y is measured, for example, as shown in FIG. 3.

In FIG. 3, a resin film (made of a polyester based resin) 123 to be measured is held between two sheets of transparent cover glass 121 and 122 used for microscopic observation. A space between each of the sheets of cover glass 121 and 122 and the resin film 123 is filled with a refractive index matching fluid (tetradecane) not shown. A sample 120 formed thus is placed on a light trap 125 and irradiated with light emitted from a light source 126. Reflectance of the light is measured by a calorimeter 127 (e.g. X-rire968) satisfying a geometric calorimetric condition of 0/45 degrees. For example, the light trap 125 has: a pipe 131 having an opened end; a table 132 provided on the opened side of the pipe 131; and a light absorption portion 133 prepared by painting the inner wall of the pipe 131 with black. Any light trap may be selected suitably if it can trap light transmitted through the sample 120.

The value of Y measured thus in a CIE XYZ color system coincides with the luminous reflectance Y. When the resin film 123 to be measured is transparent and the sheets of cover glass 121 and 122 are transparent, Y is almost equal to 0. That is, the value of Y corresponds to the strength of a scattered component in the resin film 123. When the crystalline polyester resin and the amorphous resin are melted and mixed insufficiently on this occasion, the scattering strength of the resin film 123 is so high that Y exhibits a large value. On the other hand, when mixing characteristic of the two resins is increased, scattering becomes so low that Y of the resin film 123 exhibits a small value. Accordingly, Y is an index of the melting and mixing characteristic.

It is preferable that the film thickness of the resin film 123 to be measured is 20 μm. When scattering is not higher than 2%, the value of Y is substantially in proportion to the film thickness. Accordingly, when the thickness of the resin film 123 is not exactly 20 μm, Y may be calculated based on the film thickness.

The method of producing the resin film 123 in this embodiment is not particularly limited as long as the method does not spoil the purpose of formation of a homogenous film with a uniform thickness. If the mixture of the resins is applied after dissolved in a solvent, the resins mixed may be separated from each other so that the resulting film cannot be made homogenous. Therefore, the following method may be used for obtaining a homogeneous film. That is, a film is released from a flat and good-releasability substrate placed on a hot plate or the like after the film is formed by melting the resins on the substrate and spreading the resins on the substrate with an Erichsen tester, a bar coater or the like. On this occasion, because the mixing state changes when the temperature of the hot plate is higher than the melting and mixing temperature, it is necessary to select the temperature of the hot plate to be lower by about 20° C. than the mixing temperature.

After a film (resin film 123) produced on the substrate is laminated on a transparent film such as a PET film, heated and pressed, the film may be released from the substrate and transferred onto a transfer film. A sample formed thus may be used for measuring Y. When the reflectance Y₀ of the transfer film is subtracted from the reflectance Yₜ of the sample, Y of the resin film 123 to be measured can be calculated.

Next, the crystalline polyester resin and the amorphous resin used in the adhesive toner particles will be described.

[Crystalline Polyester Resin]

The melting point of the crystalline polyester resin is in a range of from 70° C. to 110° C., preferably in a range of from 80° C. to 100° C. The weight average molecular weight of the crystalline polyester resin is in a range of from 15000 to 40000, preferably in a range of from 17000 to 30000 from the viewpoints of low temperature fixability and mechanical strength. Incidentally, in this embodiment, a differential scanning calorimeter (DSC) is used for measuring the meting point of the crystalline polyester resin. A top value of a heat absorption peak measured when the crystalline polyester resin is heated from room temperature to 150° C. at a temperature rise of 10° C. per minute is used for measuring the melting point of the crystalline polyester resin.

In this embodiment, the term “crystalline” in the phrase “crystalline polyester resin” is that the endtherm of the polyester resin does not change stepwise but has a clear heat absorption peak in the differential scanning calorimetry (DSC). When a copolymer obtained by copolymerizating another component with the crystalline polyester resin is used, the amount of the other component is small. Accordingly, such a copolymer is referred to as “crystalline polyester polymer” if the endotherm of the copolymer has a clear heat absorption peak in the differential scanning calorimetry (DSC).

In order to increase the flexibility of the resin, an alcohol-derived component of the crystalline polyester resin is preferably straight-chain aliphatic alcohol having 2-14 carbon atoms.

Aliphatic diol is preferably use as alcohol which is a constituent component of the alcohol-derived component.

Specific examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanediol. The aliphatic diol is not limited to these examples. From the viewpoint of fixing characteristic and heat resistance, straight-chain aliphatic based diol having 6-12 carbon atoms is preferred. Nonanediol having 9 carbon atoms is especially preferred.

From the viewpoint of melting and mixing characteristic and low temperature fixability, it is preferable that the amount of the straight-chain aliphatic based diol having 6-12 carbon atoms is in a range of from 85 mol % to 98 mol % based on the total amount of the alcohol-derived component of the crystalline polyester resin.

Any dicarboxylic acid such as aromatic based dicarboxylic acid and aliphatic based dicarboxylic acid may be used as the acid which is a constituent component of the acid-derived component.

Examples of the aliphatic dicarboxylic acid include oxalic acid, malonic acid, succinic acid, glutaric acid, adipic acid, pimelic acid, suberic acid, azelic acid, sebacic acid, 1,9-nonanedicarboxylic acid, 1,10-decanedicarboxylic acid, 1,11-undecanedicarboxylic acid, 1,12-dodecanedicarboxylic acid, 1,13-tridecanedicarboxylic acid, 1,14-tetradecanedicarboxylic acid, 1,16-hexadecanedicarboxylic acid, and 1,18-octadecanedicarboxylic acid, and lower alkyl ester or anhydride thereof.

Examples of the aromatic dicarboxylic acid include terephthalic acid, dimethyl terephthalate, isophthalic acid, dimethyl isophthalate, 2,6-naphthalenedicarboxylic acid, and 4,4′-biphenyldicarboxylic acid. Among them, terephthalic acid, dimethyl terephthalate, isophthalic acid, dimethyl isophthalate, and 2,6-naphthalenedicarboxylic acid are preferably used.

It is preferable that the amount of the aromatic component is not smaller than 90 mol % with respect to the total amount of the acid-derived component from the viewpoint of low temperature fixability and mechanical strength and from the viewpoint of well keeping the melting and mixing characteristic.

In order to increase the melting and mixing characteristic, it is preferable that 2 mol % to 12.5 mol % of a third component are copolymerized. If the percentage of the third component is reduced, heat resistance as well as production efficiency is deteriorated because the melting and mixing characteristic becomes so low that the mixing temperature has to be raised or the mixing time has to be elongated. On the other hand, if the percentage of the third component is beyond this range, heat resistance is deteriorated due to lowering of crystallinity though the melting and mixing characteristic is improved. If heat resistance is deteriorated, the adhesive layer toner portion kept in the condition that an image per se before adhesion is left in a high temperature warehouse or car causes problems such as blocking and offset.

A diol component such as bisphenol A, a bisphenol A-ethylene oxide adduct, a bisphenol A-propylene oxide adduct, hydrogenated bisphenol A, bisphenol S, a bisphenol S-ethylene oxide adduct or a bisphenol S-propylene oxide adduct is preferably used as the third component in order to increase the melting and mixing characteristic. From the viewpoint of heat resistance, the amount of the alcohol-derived third component is selected to be preferably in a range of from 2 mol % to 15 mol %, more preferably in a range of from 3 mol % to 8 mol % with respect to the total amount of the alcohol-derived component.

From the viewpoint of the melting and mixing characteristic, an acid-derived component may be added as the third component. When two kinds of acid-derived components are added, crystallinity is lowered and the melting and mixing characteristic is improved. In order to eliminate deterioration of heat resistance caused by lowering of crystallinity, the ratio of the third component to the total acid-derived component is preferably not higher than 10%.

When the main component is aliphatic dicarboxylic acid, aromatic dicarboxylic acid may be used as the third component by way of example. When the main component is aromatic dicarboxylic acid, aliphatic dicarboxylic acid may be used as the third component by way of example.

The method of producing the crystalline polyester resin is not particularly limited. The crystalline polyester resin may be produced by a general polyester polymerization method in which an acid component and an alcohol component are reacted with each other. That is, dibasic acid and dihydric alcohol are subjected to esterification or transesterification reaction, so that an oligomer is obtained. Then, the oligomer is subjected to polycondensation reaction in a vacuum to thereby synthesize the crystalline polyester resin. Alternatively, as described in JP-B-53-37920, the crystalline polyester resin may be also obtained by a polyester depolymerization method. After dicarboxylic alkyl ester is used as at least one of dibasic acids so as to be subjected to transesterification reaction, polycondensation reaction may be performed. Or after dicarboxylic acid is used so as to be directly esterified, polycondensation reaction may be performed.

For example, dibasic acid and dihydric alcohol are reacted with each other for 2-5 hours in an atmospheric pressure at 180-200° C. so that transesterification reaction is completed while distillation of water or alcohol is completed. Then, the reaction system is heated to 200-230° C. while the reaction system is evacuated to a high vacuum with a pressure not higher than 1 mmHg. The reaction system is heated at this temperature for 1-3 hours to thereby obtain the crystalline polyester resin.

[Amorphous Resin]

The glass transition point of the amorphous resin is preferably in a range of from 55° C. to 65° C.

A styrene acrylic based resin or a polyester based resin is preferably used as the amorphous resin.

The weight average molecular weight of the amorphous styrene acrylic based resin is preferably in a range of from 20000 to 40000. The weight average molecular weight of the amorphous polyester based resin is preferably in a range of from 8000 to 30000.

From the viewpoint of low temperature fixability and mixing characteristic, a third component may be copolymerized.

In the case of the amorphous polyester based resin, it is preferable that the amorphous polyester based resin contains an alcohol-derived component or an acid-derived component common to the crystalline polyester resin in order to increase the melting and mixing characteristic.

Particularly when the main component of the alcohol-derived component in the amorphous polyester resin is a straight-chain aliphatic component while the main component of the acid-derived component in the amorphous polyester resin is an aromatic component, and if the ratio of the alcohol-derived component of the straight-chain aliphatic component of the amorphous resin to the whole diol of the amorphous resin is in a range of from 10 mol % to 30 mol % while the ratio of the aromatic component of the acid-derived component of the amorphous resin to the whole acid-derived component of the amorphous resin is not smaller than 90 mol %, these components can be melted and mixed at a low temperature to obtain a mixture good in heat resistance because melting and mixing characteristic is increased while low temperature fixability is satisfied.

When an aromatic component which is an alcohol-derived component is contained as the third component of the amorphous polyester resin, it is particularly preferable that the ratio of the aromatic component contained as a main component of the alcohol-derived component of the amorphous polyester resin of the amorphous resin to the whole alcohol-derived component of the amorphous resin is in a range of from 70 mol % to 90 mol % from the viewpoint of melting and mixing characteristic, heat resistance and low temperature fixability.

Like the method for producing the crystalline polyester resin, the method for producing the amorphous polyester resin is not particularly limited. The amorphous polyester resin can be produced by a general polyester polymerization method as described above.

Similarly, various dicarboxylic acids such as aromatic dicarboxylic acid and aliphatic dicarboxylic acid listed in the case of the crystalline polyester resin can be used as the acid-derived component. Various diols can be used as the alcohol-derived component. For example, bisphenol A, abisphenol A-ethylene oxide adduct, a bisphenol A-propylene oxide adduct, hydrogenated bisphenol A, bisphenol S, a bisphenol S-ethylene oxide adduct, a bisphenol S-propylene oxide adduct, and so on, can be used in addition to aliphatic diols listed in the case of the crystalline polyester resin. In the case of the amorphous polyester resin, a plurality of acid-derived components or a plurality of alcohol-derived components may be used.

It is preferable that wax, inorganic fine particles, organic fine particles, and so on, besides the thermoplastic resin, may be added to the adhesive toner particles.

It is preferable that the percentage of the thermoplastic resin is 80 wt % or more. If it is smaller than 80 wt %, there is a possibility that problems such as increase in viscosity and lowering in heat resistance will rise.

It is particularly preferable that 3 wt % to 15 wt % of the inorganic fine particles are added.

The inorganic fine particles are not particularly limited as long as they do not spoil whiteness. The inorganic fine particles may be selected suitably from known fine particles in accordance with the purpose. Examples of the material of the inorganic fine particles include silica, titanium dioxide, barium sulfate, and calcium carbonate. In consideration of dispersibility into the resin, the inorganic fine particles subjected to hydrophobic treatment with a silane coupling agent, a titanium coupling agent or the like may be used.

It is especially preferable that the mean particle size of the inorganic fine particles is in a range of from 0.005 μm to 1 μm. If the mean particle size is smaller than 0.005 μm, it may be impossible to obtain a desired effect because coagulation occurs when the inorganic fine particles are mixed with the resin. On the other hand, if the mean particle size is larger than 1 μm, it is difficult to obtain satisfactory adhesion.

Addition of the inorganic fine particles causes quickening of solidification of the resin after fixing.

If the amount of the inorganic fine particles to be added is smaller than 3 wt %, there is little effect in quickening solidification. If the amount of the inorganic fine particles to be added is larger than 15 wt %, it is difficult to obtain satisfactory adhesion at a desired fixing temperature because the viscosity at the fixing temperature increases.

It is preferable that the main component of the inorganic fine particles is titanium dioxide or silica having a particle size of 8 nm to 200 nm. Even in the case where the amount of the inorganic fine particles is small, solidification can be quickened as well as the inorganic fine particles do not spoil whiteness.

Even when the organic fine particles are added, solidification of the resin after fixing can be quickened.

The organic fine particles are not particularly limited as long as they do not spoil whiteness. The organic fine particles may be selected suitably from known fine particles in accordance with the purpose. Examples of the material of the organic fine particles include a polyester based resin, a polystyrene based resin, talc, kaoline clay, a polyacrylic based resin, a vinyl based resin, a polycarbonate based resin, a polyamide based resin, a polyimide based resin, an epoxy based resin, a polyurea based resin, and a fluoro-based resin.

It is especially preferable that the mean particle size of the organic fine particles is in a range of from 0.005 μm to 1 μm. If the mean particle size is smaller than 0.005 μm, it may be impossible to obtain a desired effect because coagulation occurs when the organic fine particles are mixed with the resin. On the other hand, if the mean particle size is larger than 1 μm, it is difficult to obtain satisfactory adhesion.

The composition of wax is not particularly limited as long as the wax does not spoil the effect of the embodiment. The wax may be selected suitably from known materials used as wax, in accordance with the purpose. Examples of the material of the wax include a polyethylene based resin, and carnauba natural wax. It is preferable that the amount of wax having a melting point ranging from 80° C. to 110° C., both inclusively, is not smaller than 0.2 wt % and smaller than 8 wt %.

A method of mixing the inorganic fine particles and other additives in the resin need not be particularly limited as long as the purpose of dispersing the inorganic fine particles and the other additives in the resin uniformly can be satisfied. Any known mixing method may be used.

For example, there are a method using an extrusion type kneader for mixing white pigment and other additives in the melted resin, and a method of putting the resin, the inorganic fine particles, the other additives and a surface active agent in water and stirring them at a high speed to thereby mix and disperse them in the water. Especially, melting and mixing is preferably used in order to disperse the inorganic fine particles and the other additives uniformly in the resin.

A method for producing the adhesive toner particles is not particularly limited as long as the method can achieve the purpose of forming the adhesive toner image 13 serving as a repeelable adhesive layer in an arbitrary position on the image support 11.

For example, the following method may be used. That is, a crystalline polyester resin and an amorphous resin are melted and mixed under a predetermined condition in advance. The resin mixture and other additives are then mixed by a melt extrusion method to thereby prepare a mixture. The mixture is pulverized into a desired particle size by a pulverizer and classified to make the particle size distribution uniform.

Alternatively, the following method may be used. That is, the resins, the inorganic fine particles and other additives are mixed by a melt extrusion method. The mixture is then dispersed into water by a heatable disperser such as Clearmix to thereby prepare a water dispersion having toner particles with a toner particle size. The water dispersion is dried in a vacuum to prepare particles.

Further, the adhesive toner particles are preferably produced by coagulating and coalescing two kinds of emulsion particles based on an emulsion fluid of the crystalline polyester resin and an emulsion fluid of the amorphous resin.

That is, there is preferably used an emulsion coagulation method in which: the resin is dispersed into water by a heatable disperser such as Clearmix to thereby prepare a water dispersion having resin particles with a size of the order of submicrons; the inorganic fine particles and other additives are dispersed into and mixed with the water dispersion to prepare a mixture; and a coagulant is added to the mixture to coagulate particles with a toner size. It is preferable that Tg of the adhesive toner particles made from the two resins is lower by at least 10° C. than Tg′ of the amorphous resin.

Image Forming Apparatus

As shown in FIG. 4, in this embodiment, an image forming apparatus 20 includes an image forming unit 21, a post-process unit 23, and a connection unit 22. The image forming unit 21 forms a color toner image 12 and an adhesive toner image 13 (see FIGS. 2A and 2B) on an image support 11. The adhesive toner image 13 serves as a repeelable adhesive layer. The post-process unit 23 applies a predetermined post-process (a folding and bonding process in this embodiment) to a recording medium 10 (composed of the image support 11, the color toner images 12 and the adhesive toner image 13) formed by image forming unit 21. The connection unit 22 connects the image forming unit 21 and the post-process unit 23 to each other.

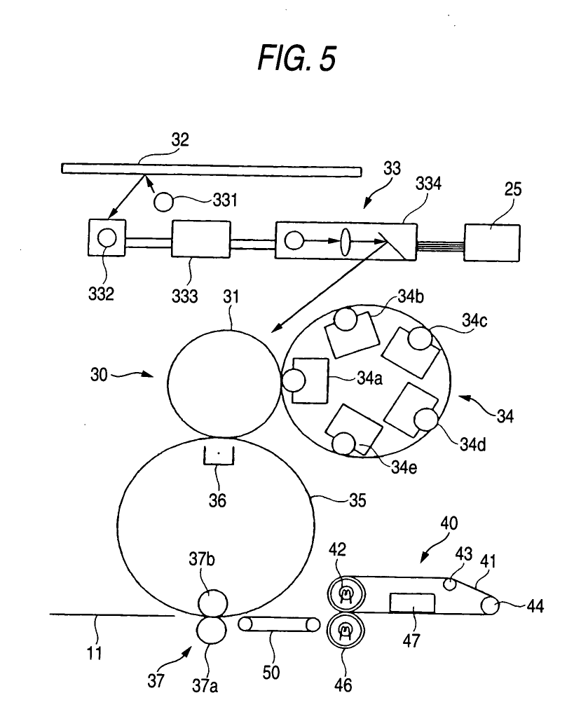

As shown in FIGS. 4 and 5, in this embodiment, the image forming unit 21 includes an image generating engine 30, and a fixing unit 40. The image generating engine 30 forms the color toner image 12 and the adhesive toner image 13 on the image support 11. The fixing unit 40 fixes the color toner image 12 and the adhesive toner image 13 formed by the image generating engine 30, on the image support 11. Incidentally, the reference numerals 38 and 39 designate supply trays for supplying the image support 11.

[Image Generating Engine]

In this embodiment, the image generating engine 30 generates not only the color toner image 12 but also the adhesive toner image 13. An example of the image generating engine 30 is a known electrophotographic image forming device. An image generating method of the image generating engine 30 is not limited to a cyclic image generation method in which an image generation cycle for generating each color component toner image and an adhesive toner image is repeated. The following method may be selected. That is, a tandem type image generation cycle for generating respective toner images successively in one cycle may be selected suitably in the condition that image generation units are provided so as to correspond to the respective toner images. It is however preferable that a constituent element for forming the adhesive toner image 13 in an arbitrary position is provided additionally.

More specifically, when the method of generating an image in a plurality of cycles is taken as example, the image generating engine 30 includes a photoconductor (e.g. photoconductor drum) 31, an electrifier not shown, an exposure device 33, a developing device 34, and a transfer device. The electrifier, the exposure device 33, the developing device 34 and the transfer device are provided around the photoconductor drum 31. The exposure device 33 exposes the photoconductor drum 31 to light so that electrostatic latent images corresponding to the respective color component toner images and the adhesive toner image are written on the photoconductor drum 31. The developing device 34 develops the respective electrostatic latent images on the photoconductor drum 31 by corresponding color toners or adhesive toner. The transfer device transfers the respective toner images on the photoconductor drum 31 to the image support 11.

In the transfer device, a technique of transferring the toner images on the photoconductor drum 31 directly to the image support 11 may be used. In this example, the transfer device has an intermediate transfer body (e.g. intermediate transfer belt) 35 opposite to the photoconductor drum 31, and there is used a technique in which toner images on the photoconductor drum 31 are once transferred to the intermediate transfer belt 35 by a primary transfer device 36, and then transferred from the intermediate transfer belt 35 to the image support 11 by a secondary transfer device 37.

A constituent element for generating the adhesive toner image 13 may be selected suitably. For example, from the viewpoint of reduction in device size, it is preferable that the adhesive toner image is generated on one photoconductor drum 31.

The photoconductor is not particularly limited. Any known photoconductor may be used. For example, a photoconductor with a single-layer structure or a separated function photoconductor with a multi-layer structure may be used. An inorganic material such as selenium or amorphous silicon or an organic material may be used as the material of the photoconductor.

Any known unit such as contact electrification using an electrically conductive or semiconductive roll, brush, film, rubber blade, etc., or corotron or scorotron electrification using corona discharge may be used in the charging device.

Any known exposure unit such as a raster output scanner (ROS) composed of a semiconductor laser, a scanning device and an optical system, an LED head or the like may be used in the exposure device 33. In consideration of a preferred embodiment for generating a uniform and high-resolution exposure image, the ROS or LED head is preferably used.

In the example, the exposure device 33 is formed so that light emitted from an illumination lamp 331 is applied onto a document 32, reflected light from the document 32 is separated into colors by a color scanner 332, the separated colors are subjected to image processing by an image processing device 333, and then, the light for writing the electrostatic latent image is applied on an exposure point of the photoconductor drum 31 through an ROS 334.

In this embodiment, the ROS 334 may be provided with an image signal forming device 25 for generating an adhesive toner image, so that when the adhesive toner image 13 is to be formed, the electrostatic latent image wiring light is applied on the exposure point of the photoconductor drum 31 through the ROS in accordance with an image signal given from the image signal forming device 25. On this occasion, it is necessary to form the electrostatic latent image on a region corresponding to the adhesive toner image 13 which should be formed in a desired position on the image support 11.

In this embodiment, a rotary type developing device having developing units 34a to 34e in which toners of respective color components such as yellow, cyan, magenta and black and adhesive toner (toner for forming an adhesive toner image as an adhesive layer) are stored is used as the developing device 34.

Any known developing unit regardless of a one-component or a two-component developing system may be used as each of the developing units 34a to 34e mounted in the developing device 34, as long as the developing unit can achieve the purpose of formation of a uniform and high-resolution toner image on the photoconductor drum 31. In order to achieve good graininess and smooth image reproducibility, developing units using a two-component developing system are preferably used. Although this example has shown the case where the rotary type developing device 34 is used, the developing device is not limited thereto. It is a matter of course that, for example, the developing units 34a to 34e may be placed side by side and around the photoconductor drum 31 so that the developing units 34a to 34e can be used selectively.

An electrically insulating or semiconductive belt material or a drum-like material having an electrically insulating or semiconductive surface can be used as the intermediate transfer body 35. In order to miniaturize the apparatus while keeping transfer performance stably at the time of generating images continuously, the electrically semiconductive belt material is preferred. As the belt material, there is known a belt material made of a resin material including an electrically conductive filler such as carbon fiber dispersed therein. As the resin, for example, a polyimide resin is preferred.

Any known unit may be used as each of the primary transfer device 36 and the secondary transfer device 37. Examples of the known unit include: unit for generating an electric field between the photoconductor drum 31 and the intermediate transfer belt 35 or between the intermediate belt 35 and the image support 11 by use of an electrically conductive or semiconductive roll, brush, film, rubber blade or the like supplied with a voltage, and transferring a toner image of electrically charged toner particles; and unit for corona-charging a rear surface of the image support 11 or the intermediate transfer belt by use of a corotron or scorotron charger using corona discharge, and transferring a toner image of electrically charged toner particles.

In this example, a transfer device having a transfer corotron disposed on a portion of the intermediate transfer belt 35 opposite to the photoconductor drum 31 is used as the primary transfer device 36, and a transfer device which includes a pair of a transfer roll 37a and a backup roll 37b disposed to sandwich the intermediate transfer belt 35 and the image support 11, and which applies a transfer electric field between the transfer roll 37a and the backup roll 37b is used as the secondary transfer device 37.

Incidentally, a cleaner for cleaning residual toner is generally provided in each of the photoconductor drum 31 and the intermediate transfer belt 35.

[Fixing Device]

In this embodiment, the fixing device 40 may be selected properly. It is preferable that the fixing device 40 includes a belt-like fixing member (fixing belt 41), a heating and pressing device, and a cooling and separating device. The heating and pressing device is provided for heating and pressing an image on the image support 11 through the belt-like fixing member. The cooling and separating device is provided for cooling and separating the image support 11 after the image is heated and pressed.

A resin film such as a polyimide resin film, or a metal film such as a stainless steel film may be used as the belt-like fixing member. Because high heat resistance temperature and good releasability are required, a member including a heat-resistant base material and a release layer laminated on the base material is preferably used as the belt-like fixing member. As the base material, a film of a resin such as a polyimide resin or a polyethylene terephthalate resin, or a belt of metal such as stainless steel is preferably used. As the material of the release layer, silicon rubber, fluoro rubber, fluororesin or the like may be preferably used.

In order to sustain stable releasability and reduce contamination with dust or the like, it is preferable that the resistance value is adjusted by dispersing electrically conductive additives such as electrically conductive carbon particles or an electrically conductor polymer.

A sheet-like member may be used as the fixing member or an endless belt-like member may be used preferably. From the viewpoint of smoothness, it is preferable that the glossness of the surface measured by a 75-degree glossimeter is 60 or more.

Any known device may be used as the heating and pressing device.

For example, there may be used a device which drives the belt-like fixing member 41 and the image support 11 having an image formed thereon while the belt-like fixing member 41 and the image support 11 are nipped between a pair of rolls driven at a constant velocity.

Here, one or each of the rolls is a device, for example, including a heat source in its inside so that the surface of the device can be heated to a temperature at which transparent toner can be melted. The two rolls are contact-pressed against each other. Preferably, a layer of silicon rubber or fluoro rubber is provided in the surface of one or each of the two rolls and the length of the region to be heated and pressed is in a range of from about 1 mm to about 8 mm.

Preferably, the surface temperature of each of the heating roll and the pressing roll in fixing is adjusted so that the viscosity of each color toner image in a rear end portion of the region (on the exit side of a fixing nip region) where the two rolls are contact-pressed against each other is not higher than 10⁴ Pa·s.

Further, as the cooling and separating device, there may be used a device having a separating member by which the image support 11 is separated from the belt-like fixing member after the image support 11 heated and pressed by the belt-like fixing member is cooled.

On this occasion, as the cooling manner, natural cooling may be used. From the viewpoint of the size of the apparatus, it is however preferable that a cooling member such as a heat sink or a heat pipe is used for increasing the cooling rate. As the form of the separating member, it is preferable that a separating claw is inserted between the belt-like fixing member and the image support 11, or a roll (separating roll) small in curvature is provided in a separation position to separate the image support 11.

Particularly in this example, the fixing device 40 includes a fixing belt (made of a belt material coated with Si rubber) 41, a heating roll 42, a separating roll 44, a pressing roll 46 (which may be additionally provided with a heat source if necessary), and a heat sink 47. The fixing belt 41 is laid on a suitable number (three in this embodiment) of stretching rolls 42 to 44. The stretching roll located on the entrance side of the fixing belt 41 is formed as the heating roll 42 which can be heated. The stretching roll located on the exit side of the fixing belt 41 is formed as the separating roll 44 so that the image support 11 can be separated. The pressing roll 46 is located opposite to the heating roll 42 while contact-pressed against the heating roll 42 so that the fixing belt 41 is nipped therebetween. The heat sink 47 is provided in the inside of the fixing belt 41 and serves as a cooling member for cooling the fixing belt 41 in the middle of the path from the heating roll 42 to the separating roll 44.

For example, a conveyance device 50 having a conveyance belt is disposed between the fixing device 40 and an image transfer portion of the image generating engine 30 where an image is transferred to the image support 11.

Connection Unit

As shown in FIG. 4, in this embodiment, the connection unit 22 has an inserter 74 on the upper portion of a unit housing. A first conveyance path 71 for conveying a recording medium 10 (equivalent to the image support 11 having the color toner image 12 and the adhesive toner image 13 formed thereon) ejected from the image forming unit 21 and a second conveyance path 72 for conveying the recording medium inserted by the inserter 74 are disposed in the unit housing so that the first conveyance path 71 and the second conveyance path 72 join to each other in the vicinity of an exit. A decurler 73 is disposed in the middle of the first conveyance path 71 so that the curl of the recording medium can be adjusted. Ejection rolls not shown are provided in the joint portion of the two conveyance paths 71 and 72.

The inserter 74 described in this specification is provided for leading a recording medium processed by another device than the image forming unit 21 or another kind of recording medium to the post-process unit 23.

Post-Process Unit

As shown in FIG. 4, in this embodiment, the post-process unit 23 includes a straight conveyance path 81, and a bypass conveyance path 82. The straight conveyance path 81 is formed so that a recording medium entrance and a recording medium exit provided on sides of the inside of the unit housing so as to be opened are connected approximately straight. The bypass conveyance path 82 is disposed to branch from the middle of the straight conveyance path 81 and bypass the side under the straight conveyance path 81. A folding mechanism 90 is disposed in the middle of the bypass conveyance path 82. A branch conveyance path 83 branches from the bypass conveyance path 82 located on the downstream side of the folding mechanism 90. A bonding device 100 is disposed in the branch conveyance path 83.

A switching gate 84 is disposed in a fork portion between the straight conveyance path 81 and the bypass conveyance path 82. A switching gate 85 is disposed in a fork portion between the bypass conveyance path 82 and the branch conveyance path 83. Ejection trays 86 and 87 are disposed in exit portions of the straight conveyance path 81 and the branch conveyance path 83, respectively.

[Folding Mechanism]

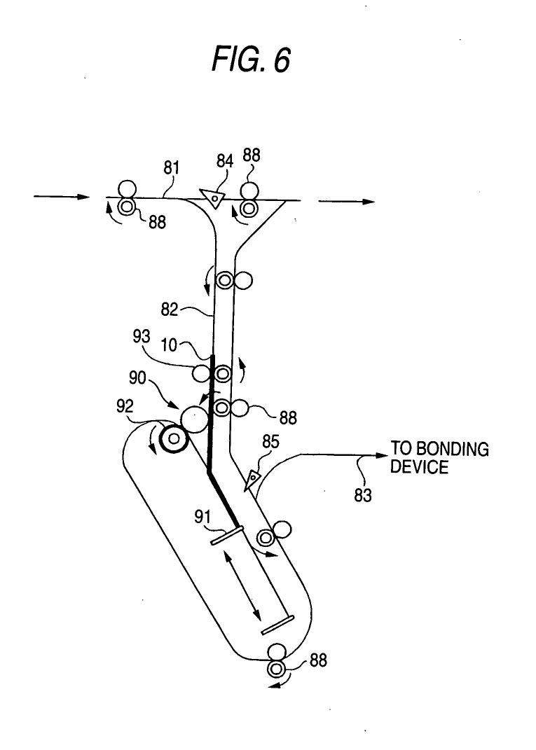

The folding mechanism 90 may be selected suitably as long as the recording medium 10 taken into the post-process unit 23 can be folded into at least two. For example, as shown in FIG. 6, the folding mechanism 90 includes an end guide 91, a pair of folding rolls 92, and nip-repeelable skew correcting rolls 93 (also serving as conveyance rolls). The end guide 91 is provided in the middle of the bypass conveyance path 82 so that the end guide 91 can catch a front end of the recording medium 10 and can move up and down in accordance with the size of the recording medium 10. The folding rolls 92 are disposed in a folding position corresponding to a center portion of the recording medium 10 caught by the end guide 91. The skew correcting rolls 93 are disposed just in front of the folding position of the bypass conveyance path 82. Incidentally, in FIG. 6, the reference numeral 88 designates a proper number of conveyance rolls disposed in the straight conveyance path 81 and the bypass conveyance path 82.

[Bonding Device]

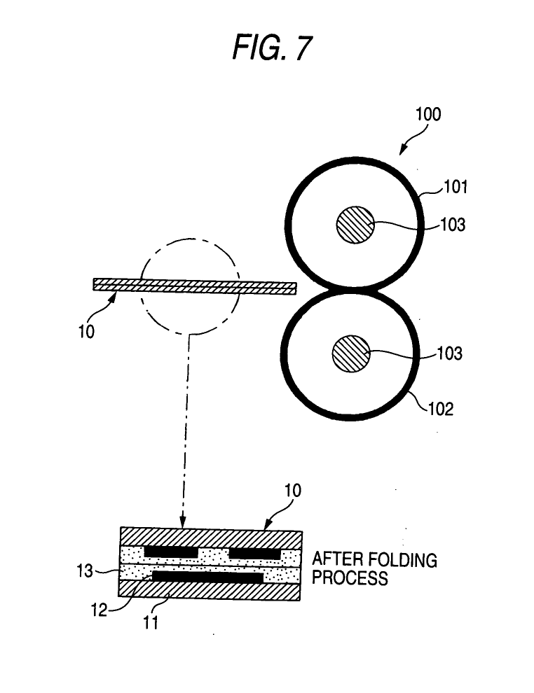

In the embodiment, the bonding device 100 is provided so that parts of the recording medium 10 folded by the folding mechanism 90 are repeelably bonded to each other through the adhesive toner image 13. A known heating and pressing device can be used as the bonding device 100. FIG. 7 shows an example of the bonding device 100.

In FIG. 7, for example, the bonding device 100 drives the folded recording medium 10 while the folded recording medium 10 is nipped between a pair of bonding rolls 101 and 102 driven at a constant velocity.

Here, one or each of the bonding rolls 101 and 102 is a device, for example, including a heat source 103 in its inside. The surface of the device can be heated to a temperature at which adhesive toner (transparent toner) can be melted. The two bonding rolls 101 and 102 are contact-pressed against each other. Preferably, a layer of silicon rubber or fluoro rubber is provided in the surface of one or each of the two bonding rolls 101 and 102 and the length of the region to be heated and pressed is in a range of from about 1 mm to about 8 mm.

Preferably, the surface temperature of each of the bonding rolls 101 and 102 is adjusted so that the viscosity of the adhesive toner image 13 in an exit side end portion of a nip region where the two rolls are contact-pressed against each other is not higher than 10³ Pa·s. Preferably, the temperature of the adhesive toner image 13 in this portion is not lower than a melting point Tm° C.

Control System

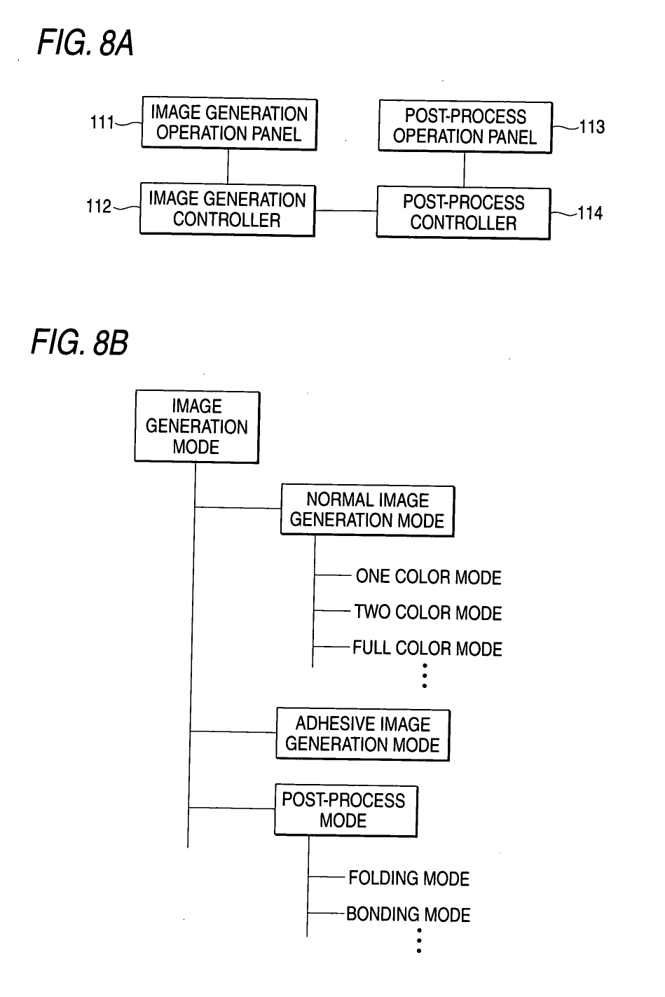

As shown in FIG. 8A, in this embodiment, an image generation operation panel 111 is provided in the image forming unit 21. An image generation controller 112 executes an image generation control process in accordance with an operation instruction given from the image generation operation panel 111.

A post-process operation panel 113 is provided in the post-process unit 23. A post-process controller 114 executes a post-process control process in accordance with an operation instruction given from the post-process operation panel 113.

As shown in FIG. 8B, particularly in this embodiment, a normal image generation mode (such as a monochrome mode, a two-color mode, a full color mode, etc.), an adhesive image generation mode (mode for generating an adhesive toner image 13) and a post-process mode (such as a folding mode, a bonding mode, etc.) are provided as selectable image generation modes. The image generation controller 112 can control not only the image forming unit 21 but also the connection unit 22 and the post-process unit 23 through the post-process controller 114.

For example, as shown in FIGS. 2A and 2B, a color toner image 12 based on full color and an adhesive toner image 13 are provided on the image support 11. When parts of the image support 11 are to be repeelably bonded after folded, a combination of the full color mode, the adhesive image generation mode and the post-process mode (the folding mode and the bonding mode) can be selected.

Next, an operation of the image forming apparatus according to this embodiment will be described.

Assume now that the full color mode, a combination of the adhesive image generation mode and the post-process mode (the folding mode and the bonding mode) is selected through the image generation operation panel 111. As shown in FIGS. 4 and 5, when an image generation start switch is turned on, light emitted from the illumination lamp 331 is first applied on a document 32 to be copied. Then, the reflected light from the document 32 is separated into colors by the color scanner 332, and data of the separated colors are applied to image processing and color correction by the image processing device 333 to thereby obtain image data of color toners. The image data of color toners and image data of an adhesive layer forming toner (adhesive toner) are transformed into modulated laser beams by the ROS 334 in accordance with the colors.

The laser beams are applied on the photoconductor drum 31 several times color by color to thereby form electrostatic latent images. The electrostatic latent images are developed successively by the yellow developing unit 34a, the magenta developing unit 34b, the cyan developing unit 34c, the black developing unit 34d and the adhesive toner developing unit 34e using toners of four colors, that is, yellow, magenta, cyan and black, and adhesive toner.

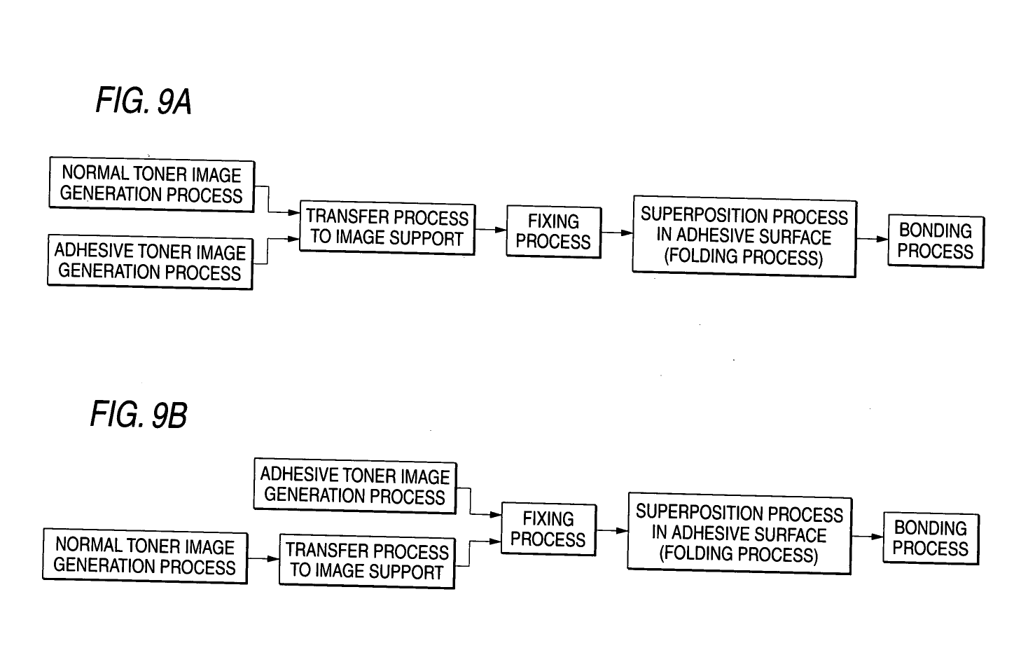

The developed color toner images 12 and the adhesive toner image 13 serving as a repeelable adhesive layer are transferred successively from the photoconductor drum 31 onto the intermediate transfer belt 35 by the primary transfer device (transfer corotron) 36. The four-color toner images 12 and the adhesive toner image 13 transferred on the intermediate transfer belt 35 are transferred collectively onto the image support 11 by the secondary transfer device 37 (see FIG. 9A).

Then, the image support 11 having the color toner images 12 and the adhesive toner image 13 transferred thereon is conveyed to the fixing device 40 via the conveyance device 50.

On this occasion, the color toner images 12 and the adhesive toner image 13 which have been not fixed yet are retained on the image support 11.

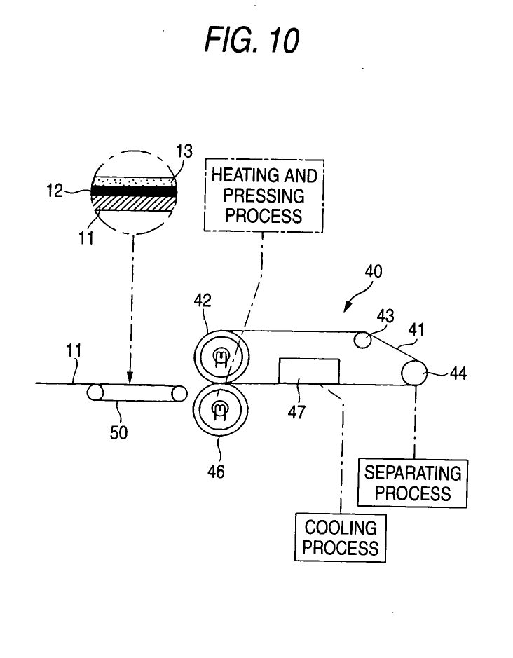

Next, an operation of the fixing device 40 will be described. As shown in FIG. 10, both the heating roll 42 and the pressing roll 46 are pre-heated to the melting temperature of toner. A force, for example, with a 100 kg load is applied between the two rolls 42 and 46. Further, the two rolls 42 and 46 are driven to rotate and the fixing belt 41 is also driven following the rotation of the rolls 42 and 46.

In the nip portion between the heating roll 42 and the pressing roll 46, the fixing belt 41 is brought into contact with the surface of the image support 11 onto which the color toner images 12 and the adhesive toner image 13 serving as a repeelable adhesive layer have been already transferred. Thus, the color toner images 12 and the adhesive toner image 13 serving as a repeelable adhesive layer are heated and melted (heating and pressing step).

Then, the image support 11 and the fixing belt 41 bonded to each other through the melted color toner layer and the melted adhesive toner layer are conveyed to the separating roll 44. During the conveyance, the fixing belt 41, the color toner images 12 and the image support 11 are cooled by the heat sink 47 (cooling step).

For this reason, when the image support 11 reaches the separating roll 44, the color toner images 12 and the adhesive toner image 13 integrated with the image support 11 are separated from the fixing belt 41 due to the curvature of the separating roll 44 (separating step).

In the abovementioned manner, the fixing process of the fixing device 40 is completed (see FIG. 9A) Thus, a recording medium 10 in which the color toner images 12 and the repeelable adhesive toner image 13 are fixed on the image support 11 is formed.

Then, as shown in FIG. 4, the recording medium 10 having the image generated by the image forming unit 21 is conveyed to the post-process unit 23 via the decurler 73 of the connection unit 22 and ejected to the ejection tray 87 via the folding mechanism 90 and the bonding device 100 in the post-process unit 23.

As shown in FIG. 6, the recording medium 10 conveyed into the post-process unit 23 is caught by the end guide 91 of the folding mechanism 90 and pulled into the folding rolls 92 while the skew correction rolls 93 are released, so that the recording medium 10 is folded into two with the color toner images 12 and the adhesive toner image 13 inward (folding step).

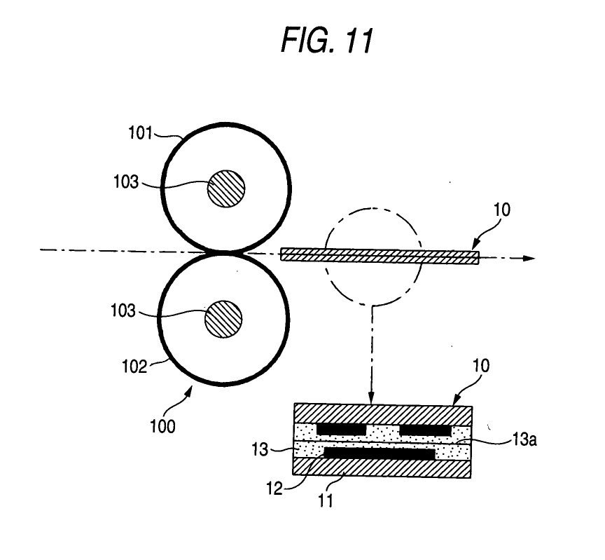

Then, as shown in FIG. 11, the recording medium 10 folded into two is inserted into the nip region between the bonding rolls 101 and 102 of the bonding device 100. On this occasion, as the temperature condition of the nip region between the two bonding rolls 101 and 102, the temperature of the nip portion is set to be higher by about 10-20° C. than the glass transition point Tg of the adhesive toner image 13 and lower by about 10-20° C. than the melting point Tm of the adhesive toner image 13 so that the adhesive toner image 13 is softened but does not flow in terms of viscosity. For example, the nip load between the two rolls 101 and 102 pressed against each other is 100 kg weight. For this reason, in the nip region of the two rolls 101 and 102, parts of the adhesive toner image 13 are softened while laminated on each other, so that the parts of the adhesive toner image 13 are bonded to each other in an adhesive surface 13a (bonding step).

### Embodiment 2

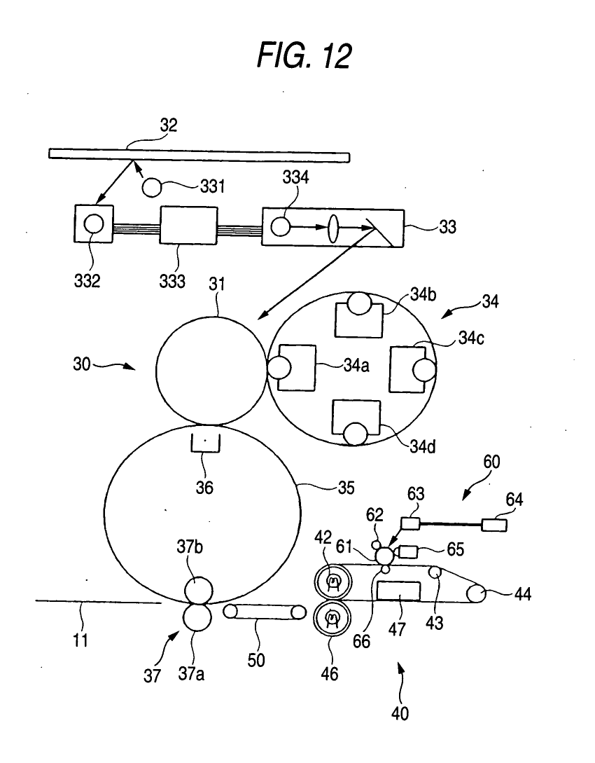

FIG. 12 shows Embodiment 2 of an image forming apparatus according to the invention.

In FIG. 12, the image forming apparatus is configured substantially in the same manner as in Embodiment 1 except that an adhesive toner image generating method different from that in Embodiment 1 is used. Incidentally, constituent elements the same as those of Embodiment 1 are referred to by numerals the same as those of Embodiment 1, and detailed description thereof will be omitted here.

That is, as shown in FIG. 12, in this embodiment, an image forming unit 21 is formed not by providing adhesive toner image generating elements (image signal forming device 25 and adhesive toner developing unit 34e) on an image generating engine 30 side but by providing an adhesive toner image generating device 60 uniquely on a fixing device 40 side.

Here, for example, the adhesive toner image generating device 60 has a photoconductor drum 61 which is disposed in a portion of the fixing device 40 opposite to the fixing belt 41 and provided for forming an adhesive toner image. An electrifier 62, an exposure device 63, an image signal forming device 64, an adhesive developing device 65 and a transfer roll 66 are provided around the photoconductor drum 61. The electrifier 62 electrically charges the photoconductor drum 61. The exposure device 63 forms an electrostatic latent image on the electrically charged photoconductor drum 61. The image signal forming device 64 sends an adhesive toner image forming region signal to the exposure device 63. The adhesive developing device 65 develops the electrostatic latent image formed on the photoconductor drum 61 by adhesive toner. The transfer roll 66 serves as a transfer device for transferring the adhesive toner image from the photoconductor drum 61 onto the fixing belt 41.

Incidentally, a general image generating system based on electrophotography can be applied directly to the adhesive toner image generating device 60.

Next, an operation of the image forming apparatus according to this embodiment will be described.

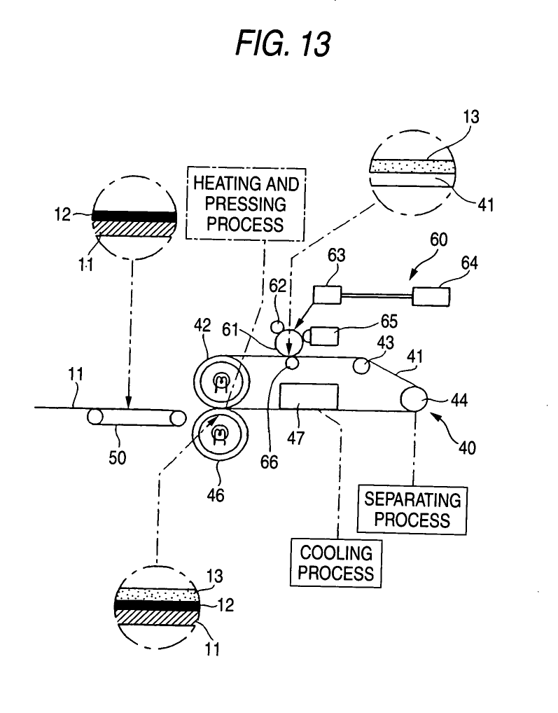

As shown in FIGS. 12 and 13, normal toner images, e.g. only color toner images 12 are formed on the image support 11 by the image generating engine 30 and conveyed to the fixing device 40 via the conveyance device 50 (see FIG. 9B).

On the other hand, the adhesive toner image generating device 60 forms an electrostatic latent image on the photoconductor drum 61 on the basis of an image signal given from the image signal forming device 64 and develops the electrostatic latent image on the photoconductor drum 61 by the adhesive developing device 65 using adhesive toner. The adhesive toner image generating device 60 then applies a transfer electric field on the transfer roll 66 to thereby transfer the adhesive toner image 13 from the photoconductor drum 61 onto the fixing belt 41.

Then, in the nip region between the heating roll 42 and the pressing roll 46, the adhesive toner image 13 transferred on the fixing belt 41 is aligned with the image support 11 having the color toner images 12 formed thereon, and heated and pressed. The recording medium 10 in which the toner images 12 and 13 are formed on the image support 11 is cooled by the heat sink 47 of the fixing device 40 and then separated from the fixing belt 41 by the separating roll 44. Thus, the color toner images 12 and the adhesive toner image 13 are fixed on the image support 11 (see FIG. 9B).

The recording medium 10 formed thus is conveyed to the post-process unit 23 via the connection unit 22 in the same manner as that in Embodiment 1. Then, the recording medium 10 is ejected to the ejection tray 87 after a folding process performed by the folding mechanism 90 and a bonding process performed by the bonding device 100.

### Embodiment 3

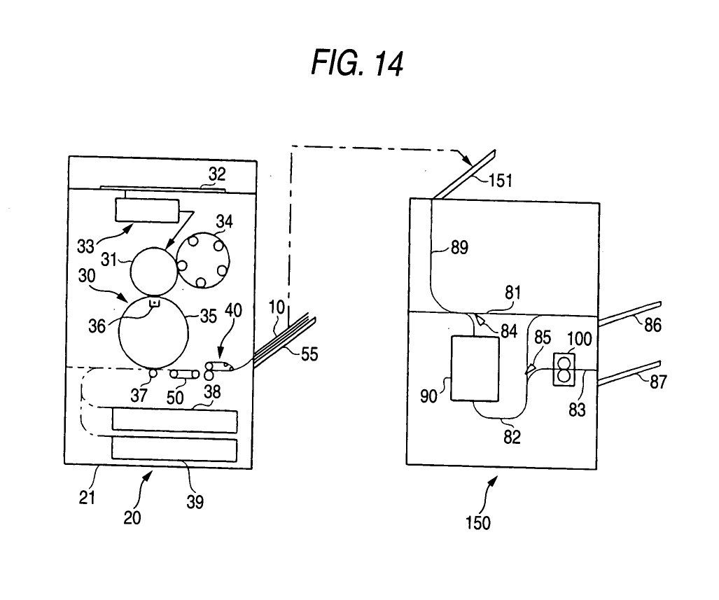

FIG. 14 shows Embodiment 3 of an image forming apparatus to which the invention is applied.

In FIG. 14, the image forming apparatus 20 includes only an image forming unit 21 according to Embodiment 1. In the image forming apparatus 20, a recording medium 10 (in which color toner images 12 and an adhesive toner image 13 are formed on the image support 11) which has passed through the image generating engine 30 and the fixing device 40 is once ejected to an ejection tray 55.

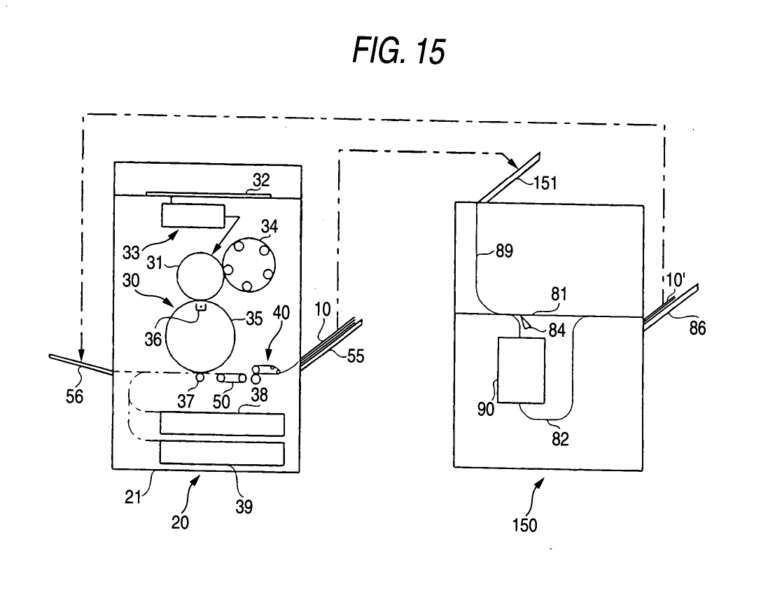

In this embodiment, a post-process apparatus 150 is provided separately from the image forming apparatus 20. Approximately similarly to the post-process unit 23 in Embodiment 1, the post-process apparatus 150 includes a folding mechanism 90, and an adhesion device 100. The reference numeral 151 in FIG. 15 designates an inserter disposed on an upper portion of a post-process apparatus housing. A recording medium 10 inserted from the inserter 151 is led to a straight conveyance path 81 via a carry-in conveyance path 89 in the post-process apparatus housing. Incidentally, constituent elements the same as those in Embodiment 1 are referred to by numerals the same as those in Embodiment 1, and detailed description thereof will be omitted here.

According to this embodiment, the recording medium 10 in which the color toner images 12 and the adhesive toner image 13 are formed on the image support 11 is once output from the image forming apparatus 20. The recording medium 10 is taken into the other, post-process apparatus 150 through the inserter 151 so that a predetermined post-process (a folding process performed by the folding mechanism 90 and a bonding process performed by the adhesion device 100) is applied to the recording medium 10.

### Embodiment 4

FIG. 15 shows Embodiment 4 of an image forming apparatus to which the invention is applied.

In this embodiment, the image forming apparatus 20 includes only an image forming unit 21 according to Embodiment 1. In the image forming apparatus 20, a recording medium 10 (in which color toner images 12 and an adhesive toner image 13 are formed on the image support 11) which has passed through the image generating engine 30 and the fixing device 40 is once ejected to an ejection tray 55.

Particularly in the embodiment, the fixing device 40 independently performs a bonding process different from a normal fixing process, when the bonding mode is selected.

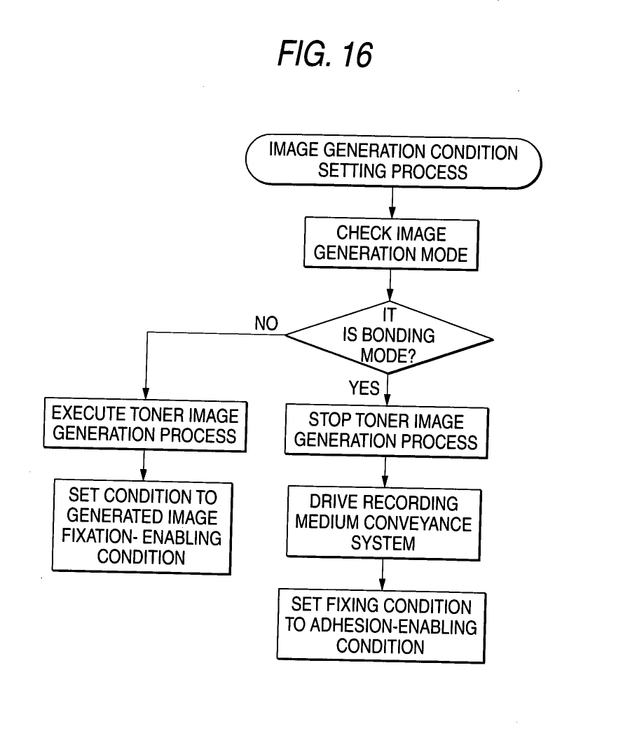

In this case, for example, an image generation controller performs an image generation condition setting process as shown in FIG. 16.

That is, the image generation controller checks the image forming mode. When the bonding mode is selected, the image generation controller stops a toner image generating process, drives a recording medium conveyance system and sets the fixing condition of the fixing device to a bonding-enabling condition. On the other hand, when the bonding mode is not selected, the image generation controller executes the toner image generating process and sets the fixing condition of the fixing device 40 to a generated image fixation-enabling condition.

In this embodiment, a post-process apparatus 150 is provided separately from the image forming apparatus 20. For example, the post-process apparatus 150 is different from that in Embodiment 3, that is, the post-process apparatus 150 does not have a bonding device 100 but has a folding mechanism 90 alone.

Hence, in accordance with this embodiment, a recording medium 10 in which color toner images 12 and an adhesive toner image 13 are formed on the image support 11 is output once. After the recording medium 10 is then folded, for example, by the folding mechanism 90 of the post-process apparatus 150, the folded recording medium 10′ is taken into the image forming apparatus 20, for example, from a manual insertion tray 56 of the image forming apparatus 20. When the adhesion process mode is selected, the fixing device 40 serves as a bonding device. Thus, the folded parts of the recording medium 10 can be repeelably bonded to each other through the adhesive toner image 13.

Here, in the bonding mode, the temperature of each of the heating roll 42 and the pressing roll 46 can be set to be higher by about 10-20° C. than the glass transition point Tg of the adhesive toner image 13 and lower by about 10-20° C. than the melting point Tm of the adhesive toner image 13 so that the adhesive toner image 13 is softened but does not flow.

Although this embodiment has been described on the case where a folding process is carried out in the post-process apparatus 150 including the folding mechanism 90, the invention is applicable, for example, to the case where the recording medium 10 output from the image forming apparatus 20 is folded manually and then subjected to a bonding process of the image forming apparatus 20.

### EXAMPLES

Next, description will be given to crystalline polyester resins A to L and amorphous resins M to Q used for adhesive toners and color toners in the following Examples 1 to 7 and Comparative Examples 1 to 9.

[Production of Crystalline Polyester Resins]

Crystalline Polyester Resin A: Sebacic acid/ND/BPA=100/95/5 (Molar Ratio)

Here, ND designates nonanediol and BPA designates a bisphenol A ethylene oxide adduct.

Into a heated and dried three-necked flask, 202 parts by weight of sebacic acid, 152 parts by weight of 1,9-nonanediol, 15.8 parts by weight of the bisphenol A ethylene oxide adduct and 0.15 parts by weight of dibutyl tin oxide as a catalyst were put. Then, nitrogen gas was substituted for the air inside the flask by a pressure reducing operation so that the flask was set to be under an inert atmosphere. Then, these components were agitated for five hours at 180° C. in a mechanical agitation manner.

Then, under the reduced pressure, the temperature was raised gradually to 250° C., and the mixture was then agitated for two hours. When the mixture became viscous, the mixture was cooled by air and reaction was stopped. The obtained resin was a crystalline polyester resin A.

In accordance with molecular weight measurement (polystyrene basis) by gel permeation chromatography, the weight average molecular weight (Mw) of the obtained crystalline polyester resin A was 22000 and the number average molecular weight (Mn) of the obtained crystalline polyester resin A was 11000.

When the melting point (Tm) of the crystalline polyester resin A was measured by a differential scanning calorimeter (DSC) by the aforementioned measurement method, the melting point (Tm) had a distinct peak and the temperature of the peak top was 72° C.

Crystalline Polyester Resin B: Dodecanedioic Acid/ND/BPS=100/95/5 (Molar Ratio)

Here, BPS designates a bisphenol S ethylene oxide adduct.

Into a heated and dried three-necked flask, 230 parts by weight of dodecanedioic acid, 152 parts by weight of 1,9-nonanediol, 16.9 parts by weight of the bisphenol S ethylene oxide adduct and 0.15 parts by weight of dibutyl tin oxide as a catalyst were put. Then, nitrogen gas was substituted for the air inside the flask by a pressure reducing operation so that the flask was set to be under an inert atmosphere. Then, these components were agitated for five hours at 180° C. in a mechanical agitation manner.

Then, under the reduced pressure, the temperature was raised gradually to 250° C., and the mixture was then agitated for two hours. When the mixture became viscous, the mixture was cooled by air and reaction was stopped. The obtained resin was a crystalline polyester resin B.

In accordance with molecular weight measurement (polystyrene basis) by gel permeation chromatography, the weight average molecular weight (Mw) of the obtained crystalline polyester resin B was 23000 and the number average molecular weight (Mn) of the obtained crystalline polyester resin B was 12000.

When the melting point (Tm) of the crystalline polyester resin B was measured by a differential scanning calorimeter (DSC) by the aforementioned measurement method, the melting point (Tm) had a distinct peak and the temperature of the peak top was 74° C.

Crystalline Polyester Resin C: Sebacic Acid/Ethylene Glycol/BPS=100/95/5 (Molar Ratio)

Into a heated and dried three-necked flask, 202 parts by weight of sebacic acid, 62 parts by weight of ethylene glycol, and 0.15 parts by weight of dibutyl tin oxide as a catalyst were put. Then, nitrogen gas was substituted for the air inside the flask by a pressure reducing operation so that the flask was set to be under an inert atmosphere. Then, these components were agitated for five hours at 180° C. in a mechanical agitation manner.

Then, under the reduced pressure, the temperature was raised gradually to 250° C., and the mixture was then agitated for two hours. When the mixture became viscous, the mixture was cooled by air and reaction was stopped. The obtained resin was a crystalline polyester resin C.

In accordance with molecular weight measurement (polystyrene basis) by gel permeation chromatography, the weight average molecular weight (Mw) of the obtained crystalline polyester resin C was 22000 and the number average molecular weight (Mn) of the obtained crystalline polyester resin C was 11000.

When the melting point (Tm) of the crystalline polyester resin C was measured by a differential scanning calorimeter (DSC) by the aforementioned measurement method, the melting point (Tm) had a distinct peak and the temperature of the peak top was 72° C.

Crystalline Polyester Resin D: Sebacic Acid/Butadiol=100/100 (Molar Ratio)

Into a heated and dried three-necked flask, 202 parts by weight of sebacic acid, 90 parts by weight of 1,6-butadiol, and 0.15 parts by weight of dibutyl tin oxide as a catalyst were put. Then, nitrogen gas was substituted for the air inside the flask by a pressure reducing operation so that the flask was set to be under an inert atmosphere. Then, these components were agitated for five hours at 180° C. in a mechanical agitation manner.

Then, under the reduced pressure, the temperature was raised gradually to 250° C., and the mixture was then agitated for two hours. When the mixture became viscous, the mixture was cooled by air and reaction was stopped. The obtained resin was a crystalline polyester resin D.

In accordance with molecular weight measurement (polystyrene basis) by gel permeation chromatography, the weight average molecular weight (Mw) of the obtained crystalline polyester resin D was 24000 and the number average molecular weight (Mn) of the obtained crystalline polyester resin D was 13000.

When the melting point (Tm) of the crystalline polyester resin D was measured by a differential scanning calorimeter (DSC) by the aforementioned measurement method, the melting point (Tm) had a distinct peak and the temperature of the peak top was 68° C.

Crystalline Polyester Resin E: Dodecanedioic Acid/Hexanediol=50/50 (Molar Ratio)

Into a heated and dried three-necked flask, 230 parts by weight of dodecanedioic acid, 90 parts by weight of 1,6-hexanediol, 136 parts by weight of ethylene glycol and 0.15 parts by weight of dibutyl tin oxide as a catalyst were put. Then, nitrogen gas was substituted for the air inside the flask by a pressure reducing operation so that the flask was set to be under an inert atmosphere. Then, these components were agitated for five hours at 180° C. in a mechanical agitation manner. Methanol and excessive ethylene glycol generated due to reaction were distilled off under reduced pressure. Then, under the reduced pressure, the temperature was raised gradually to 250° C., and the mixture was then agitated for two hours. When the mixture became viscous, the mixture was cooled by air and reaction was stopped. The obtained resin was a crystalline polyester resin E.

In accordance with molecular weight measurement (polystyrene basis) by gel permeation chromatography, the weight average molecular weight (Mw) of the obtained crystalline polyester resin E was 30000 and the number average molecular weight (Mn) of the obtained crystalline polyester resin E was 14000.

When the melting point (Tm) of the crystalline polyester resin E was measured by a differential scanning calorimeter (DSC) by the aforementioned measurement method, the melting point (Tm) had a distinct peak and the temperature of the peak top was 75° C.

Crystalline Polyester Resin F: Succinic Acid/Ethylene Glycol=50/50 (Molar Ratio)

Into a heated and dried three-necked flask, 118 parts by weight of succinic acid, 62 parts by weight of ethylene glycol, and 0.15 parts by weight of dibutyl tin oxide as a catalyst were put. Then, nitrogen gas was substituted for the air inside the flask by a pressure reducing operation so that the flask was set to be under an inert atmosphere. Then, these components were agitated for five hours at 180° C. in a mechanical agitation manner.

Then, under the reduced pressure, the temperature was raised gradually to 250° C., and the mixture was then agitated for two hours. When the mixture became viscous, the mixture was cooled by air and reaction was stopped. The obtained resin was a crystalline polyester resin F.

In accordance with molecular weight measurement (polystyrene basis) by gel permeation chromatography, the weight average molecular weight (Mw) of the obtained crystalline polyester resin F was 22000 and the number average molecular weight (Mn) of the obtained crystalline polyester resin F was 10900.

When the melting point (Tm) of the crystalline polyester resin F was measured by a differential scanning calorimeter (DSC) by the aforementioned measurement method, the melting point (Tm) had a distinct peak and the temperature of the peak top was 102° C.

Crystalline Polyester Resin G: Adipic Acid/Xylylene Glycol=50/50 (Molar Ratio)

Into a heated and dried three-necked flask, 146 parts by weight of adipic acid, 138 parts by weight of xylylene glycol, and 0.15 parts by weight of dibutyl tin oxide as a catalyst were put. Then, nitrogen gas was substituted for the air inside the flask by a pressure reducing operation so that the flask was set to be under an inert atmosphere. Then, these components were agitated for five hours at 180° C. in a mechanical agitation manner.

Then, under the reduced pressure, the temperature was raised gradually to 250° C., and the mixture was then agitated for two hours. When the mixture became viscous, the mixture was cooled by air and reaction was stopped. The obtained resin was a crystalline polyester resin G.

In accordance with molecular weight measurement (polystyrene basis) by gel permeation chromatography, the weight average molecular weight (Mw) of the obtained crystalline polyester resin G was 19000 and the number average molecular weight (Mn) of the obtained crystalline polyester resin G was 9000.

When the melting point (Tm) of the crystalline polyester resin G was measured by a differential scanning calorimeter (DSC) by the aforementioned measurement method, the melting point (Tm) had a distinct peak and the temperature of the peak top was 86° C.

Crystalline Polyester Resin H: TPA/ND/BPA=50/47.5/2.5 (Molar Ratio)

Here, TPA designates terephthalic acid.

Into a heated and dried three-necked flask, 194 parts by weight of dimethyl terephthalate, 152 parts by weight of 1,9-nonanediol, 15.8 parts by weight of the bisphenol A ethylene oxide adduct and 0.15 parts by weight of dibutyl tin oxide as a catalyst were put. Then, nitrogen gas was substituted for the air inside the flask by a pressure reducing operation so that the flask was set to be under an inert atmosphere. Then, these components were agitated for five hours at 180° C. in a mechanical agitation manner.

Then, under the reduced pressure, the temperature was raised gradually to 230° C., and the mixture was then agitated for two hours. When the mixture became viscous, the mixture was cooled by air and reaction was stopped. The obtained resin was a crystalline polyester resin H.

In accordance with molecular weight measurement (polystyrene basis) by gel permeation chromatography, the weight average molecular weight (Mw) of the obtained crystalline polyester resin H was 22000 and the number average molecular weight (Mn) of the obtained crystalline polyester resin H was 10900.

When the melting point (Tm) of the crystalline polyester resin H was measured by a differential scanning calorimeter (DSC) by the aforementioned measurement method, the melting point (Tm) had a distinct peak and the temperature of the peak top was 94° C.

Crystalline Polyester Resin I: TPA/ND/BPS=100/95/5 (Molar Ratio)

Into a heated and dried three-necked flask, 194 parts by weight of dimethyl terephthalate, 152 parts by weight of 1,9-nonanedoil, 16.9 parts by weight of the bisphenol S ethylene oxide adduct, and 0.15 parts by weight of dibutyl tin oxide as a catalyst were put. Then, nitrogen gas was substituted for the air inside the flask by a pressure reducing operation so that the flask was set to be under an inert atmosphere. Then, these components were agitated for five hours at 180° C. in a mechanical agitation manner.

Then, under the reduced pressure, the temperature was raised gradually to 230° C., and the mixture was then agitated for two hours. When the mixture became viscous, the mixture was cooled by air and reaction was stopped. The obtained resin was a crystalline polyester resin I.

In accordance with molecular weight measurement (polystyrene basis) by gel permeation chromatography, the weight average molecular weight (Mw) of the obtained crystalline polyester resin I was 23000 and the number average molecular weight (Mn) of the obtained crystalline polyester resin I was 12000.

When the melting point (Tm) of the crystalline polyester resin I was measured by a differential scanning calorimeter (DSC) by the aforementioned measurement method, the melting point (Tm) had a distinct peak and the temperature of the peak top was 92° C.

Crystalline Polyester Resin J: TPA/ND/BPS=100/90/10 (Molar Ratio)

Into a heated and dried three-necked flask, 194 parts by weight of dimethyl terephthalate, 144 parts by weight of 1,9-nonanedoil, 31.6 parts by weight of the bisphenol A ethylene oxide adduct, and 0.15 parts by weight of dibutyl tin oxide as a catalyst were put. Then, nitrogen gas was substituted for the air inside the flask by a pressure reducing operation so that the flask was set to be under an inert atmosphere. Then, these components were agitated for five hours at 180° C. in a mechanical agitation manner.

Then, under the reduced pressure, the temperature was raised gradually to 230° C., and the mixture was then agitated for two hours. When the mixture became viscous, the mixture was cooled by air and reaction was stopped. The obtained resin was a crystalline polyester resin J.

In accordance with molecular weight measurement (polystyrene basis) by gel permeation chromatography, the weight average molecular weight (Mw) of the obtained crystalline polyester resin J was 22000 and the number average molecular weight (Mn) of the obtained crystalline polyester resin J was 11000.

When the melting point (Tm) of the crystalline polyester resin J was measured by a differential scanning calorimeter (DSC) by the aforementioned measurement method, the melting point (Tm) had a distinct peak and the temperature of the peak top was 90° C.

Crystalline Polyester Resin K: TPA/ND=100/100 (Molar Ratio)

Into a heated and dried three-necked flask, 194 parts by weight of dimethyl terephthalate, 160 parts by weight of 1,9-nonanedoil, and 0.15 parts by weight of dibutyl tin oxide as a catalyst were put. Then, nitrogen gas was substituted for the air inside the flask by a pressure reducing operation so that the flask was set to be under an inert atmosphere. Then, these components were agitated for five hours at 180° C. in a mechanical agitation manner.

Then, under the reduced pressure, the temperature was raised gradually to 230° C., and the mixture was then agitated for two hours. When the mixture became viscous, the mixture was cooled by air and reaction was stopped. The obtained resin was a crystalline polyester resin K.

In accordance with molecular weight measurement (polystyrene basis) by gel permeation chromatography, the weight average molecular weight (Mw) of the obtained crystalline polyester resin K was 24000 and the number average molecular weight (Mn) of the obtained crystalline polyester resin K was 13000.

When the melting point (Tm) of the crystalline polyester resin K was measured by a differential scanning calorimeter (DSC) by the aforementioned measurement method, the melting point (Tm) had a distinct peak and the temperature of the peak top was 95° C.

Crystalline Polyester Resin L: TPA/ND/BPA=100/95/5 (Molar Ratio)

Into a heated and dried three-necked flask, 194 parts by weight of dimethyl terephthalate, 152 parts by weight of 1,9-nonanedoil, 15.8 parts by weight of the bisphenol A ethylene oxide adduct, 136 parts by weight of ethylene glycol, and 0.15 parts by weight of dibutyl tin oxide as a catalyst were put. Then, nitrogen gas was substituted for the air inside the flask by a pressure reducing operation so that the flask was set to be under an inert atmosphere. Then, these components were agitated for five hours at 180° C. in a mechanical agitation manner. Methanol and excessive ethylene glycol generated due to reaction were distilled off under reduced pressure. Then, under the reduced pressure, the temperature was raised gradually to 220° C., and the mixture was then agitated for two hours. When the mixture became viscous, the mixture was cooled by air and reaction was stopped. The obtained resin was a crystalline polyester resin L.

In accordance with molecular weight measurement (polystyrene basis) by gel permeation chromatography, the weight average molecular weight (Mw) of the obtained crystalline polyester resin L was 43000 and the number average molecular weight (Mn) of the obtained crystalline polyester resin L was 22000.

When the melting point (Tm) of the crystalline polyester resin L was measured by a differential scanning calorimeter (DSC) by the aforementioned measurement method, the melting point (Tm) had a distinct peak and the temperature of the peak top was 96° C.

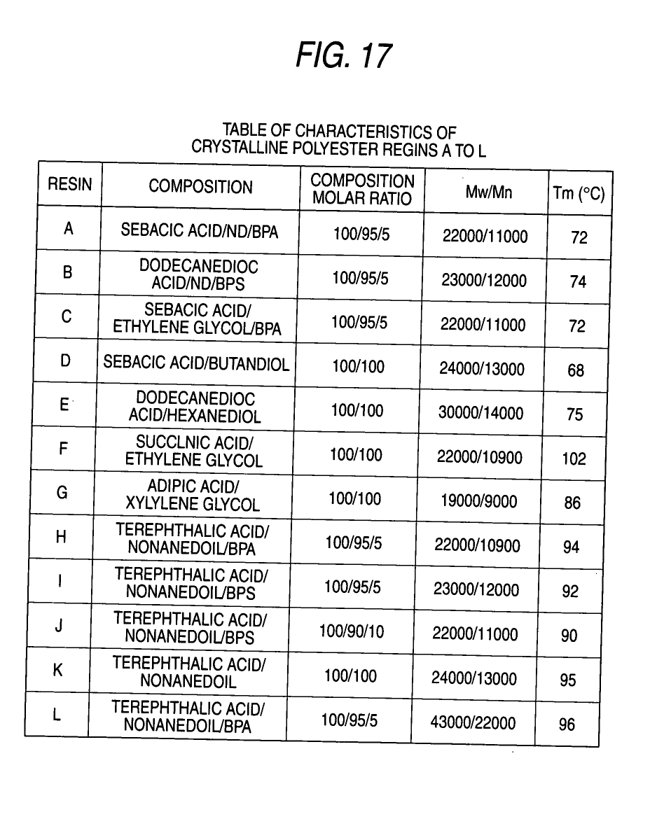

Here, FIG. 17 shows a table of the produced crystalline polyester resins A to L.

[Production of Amorphous Resins]

Amorphous Resin M: TPA/ND/BPS=100/25/75 (Molar Ratio)

Into a heated and dried three-necked flask, 194 parts by weight of dimethyl terephthalate, 40 parts by weight of 1,9-nonanedoil, 237 parts by weight of the bisphenol S ethylene oxide adduct, and 0.15 parts by weight of dibutyl tin oxide as a catalyst were put. Then, nitrogen gas was substituted for the air inside the flask by a pressure reducing operation so that the flask was set to be under an inert atmosphere. Then, these components were agitated for five hours at 180° C. in a mechanical agitation manner.

Then, under the reduced pressure, the temperature was raised gradually to 230° C., and the mixture was then agitated for two hours. When the mixture became viscous, the mixture was cooled by air and reaction was stopped. The obtained resin was an amorphous polyester resin M.

In accordance with molecular weight measurement (polystyrene basis) by gel permeation chromatography, the weight average molecular weight (Mw) of the obtained amorphous polyester resin M was 13000 and the number average molecular weight (Mn) of the obtained amorphous polyester resin M was 6000.

When the melting point (Tm) of the amorphous polyester resin M was measured by a differential scanning calorimeter (DSC) by the aforementioned measurement method, the melting point (Tm) did not exhibit a distinct peak but stepwise endothermic change was observed. The glass transition point (Tg) taken as the intermediate point of the stepwise endothermic change amount was 58° C.

Amorphous Resin N: TPA/ND/BPS=100/15/85 (Molar Ratio)

Into a heated and dried three-necked flask, 194 parts by weight of dimethyl terephthalate, 47 parts by weight of 1,9-nonanedoil, 136 parts by weight of the bisphenol S ethylene oxide adduct, and 0.15 parts by weight of dibutyl tin oxide as a catalyst were put. Then, nitrogen gas was substituted for the air inside the flask by a pressure reducing operation so that the flask was set to be under an inert atmosphere. Then, these components were agitated for five hours at 180° C. in a mechanical agitation manner.

Then, under the reduced pressure, the temperature was raised gradually to 230° C., and the mixture was then agitated for two hours. When the mixture became viscous, the mixture was cooled by air and reaction was stopped. The obtained resin was an amorphous polyester resin N.

In accordance with molecular weight measurement (polystyrene basis) by gel permeation chromatography, the weight average molecular weight (Mw) of the obtained amorphous polyester resin N was 12000 and the number average molecular weight (Mn) of the obtained amorphous polyester resin N was 5600.

When the melting point (Tm) of the amorphous polyester resin N was measured by a differential scanning calorimeter (DSC) by the aforementioned measurement method, the melting point (Tm) did not exhibit a distinct peak but stepwise endothermic change was observed. The glass transition point (Tg) taken as the intermediate point of the stepwise endothermic change amount was 62° C.

Amorphous Resin O: TPA/BPA=100/100 (Molar Ratio)

Into a heated and dried three-necked flask, 194 parts by weight of dimethyl terephthalate, 316 parts by weight of the bisphenol A ethylene oxide adduct, and 0.15 parts by weight of dibutyl tin oxide as a catalyst were put. Then, nitrogen gas was substituted for the air inside the flask by a pressure reducing operation so that the flask was set to be under an inert atmosphere. Then, these components were agitated for five hours at 180° C. in a mechanical agitation manner.

Then, under the reduced pressure, the temperature was raised gradually to 230° C., and the mixture was then agitated for two hours. When the mixture became viscous, the mixture was cooled by air and reaction was stopped. The obtained resin was an amorphous polyester resin O.

In accordance with molecular weight measurement (polystyrene basis) by gel permeation chromatography, the weight average molecular weight (Mw) of the obtained amorphous polyester resin O was 13000 and the number average molecular weight (Mn) of the obtained amorphous polyester resin O was 6000.

When the melting point (Tm) of the amorphous polyester resin O was measured by a differential scanning calorimeter (DSC) by the aforementioned measurement method, the melting point (Tm) did not exhibit a distinct peak but stepwise endothermic change was observed. The glass transition point (Tg) taken as the intermediate point of the stepwise endothermic change amount was 82° C.

Amorphous Resin P: TPA/BPA/CHDM=100/80/20 (Molar Ratio)

Here, CHDM designates cyclohexane dimethanol.

Into a heated and dried three-necked flask, 194 parts by weight of dimethyl terephthalate, 253 parts by weight of the bisphenol A ethylene oxide adduct, 28.8 parts by weight of cyclohexane dimethanol and 0.15 parts by weight of dibutyl tin oxide as a catalyst were put. Then, nitrogen gas was substituted for the air inside the flask by a pressure reducing operation so that the flask was set to be under an inert atmosphere. Then, these components were agitated for five hours at 180° C. in a mechanical agitation manner.

Then, under the reduced pressure, the temperature was raised gradually to 230° C., and the mixture was then agitated for two hours. When the mixture became viscous, the mixture was cooled by air and reaction was stopped. The obtained resin was an amorphous polyester resin P.

In accordance with molecular weight measurement (polystyrene basis) by gel permeation chromatography, the weight average molecular weight (Mw) of the obtained amorphous polyester resin P was 10000 and the number average molecular weight (Mn) of the obtained amorphous polyester resin P was 4500.

When the melting point (Tm) of the amorphous polyester resin P was measured by a differential scanning calorimeter (DSC) by the aforementioned measurement method, the melting point (Tm) did not exhibit a distinct peak but stepwise endothermic change was observed. The glass transition point (Tg) taken as the intermediate point of the stepwise endothermic change amount was 62° C.

Amorphous Resin Q: Styrene/Butyl Acrylate/Acrylic Acid=100/57/3 (Molar Ratio)

| | | |
|---|---|---|
| Styrene | 320 | parts by weight |
| n-butyl Acrylate | 75 | parts by weight |
| Acrylic Acid | 8 | parts by weight |
| Dodecanediol | 6 | parts by weight |
| Carbon Tetrabromide | 4 | parts by weight |

A solution obtained by mixing these components, 6 parts by weight of a nonionic surface-active agent (NONIPOL 400 made by Sanyo Chemical Industries, Ltd.) and 10 parts by weight of an anionic surface-active agent (Neogene R made by Daiichi Pharmaceutical Co., Ltd.,) were dissolved in 550 parts by weight of ion exchange water so as to prepare a solution. After being put into a flask, the prepared solution was dispersed and emulsified. While the solution was agitated and mixed for ten minutes, 50 parts by weight of ion exchange water containing 4 parts by weight of ammonium persulfate dissolved therein were put into the solution. After nitrogen was then substituted for the air inside the flask, the mixture was heated while agitated in an oil bath so that the temperature inside the system was 70° C. The solution was polymerized as it is for five hours.

A latex obtained thus was dried in a vacuum so as to obtain an amorphous resin Q.

By a differential scanning calorimeter (DSC-50 made by Shimadzu Corp.) at a temperature increase rate of 10° C. per minute, the glass transition point (Tg) of the resin was measured to be 53° C. By a molecular weight measuring instrument (HLC-8020 made by Tosoh Corp.) and with THF used as a solvent, the weight average molecular weight (polystyrene basis) of the resin was measured to be 33000.

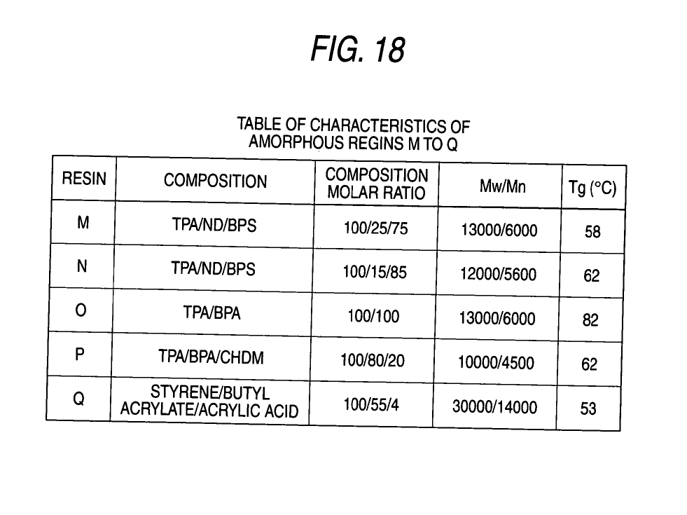

Here, FIG. 18 shows a table of the amorphous resins M to Q produced thus.

[Color Toner Developing Agents]

Color Toner Developing Agents a:

Linear polyester obtained from terephthalic acid/bisphenol A ethylene oxide adduct/cyclohexane dimethanol (molar ratio=5:4:1, Tg=62° C., Mn=6000 and Mw=12000) was used as a binder resin. With 100 parts by weight of the linear polyester, 5 parts by weight of benzidine yellow used as a colorant were mixed in the case of a yellow toner, 4 parts by weight of pigment red used as a colorant were mixed in the case of a magenta toner, 4 parts by weight of phthalocyanine blue used as a colorant were mixed in the case of a cyan toner, and 5 parts by weight of carbon black used as a colorant were mixed in the case of a black toner, respectively. Each mixture for each color was melted by heat and mixed by a Banbury mixer. The resulting mixture was pulverized by a jet mill and then classified by an air classifier. Thus, fine particles with d50=7 μm were produced.

The following two kinds of inorganic fine particles x and y were deposited on 100 parts by weight of the produced fine particles by a high speed mixer.

The inorganic fine particles x are made of SiO₂ (silane coupling agent having its surface subjected to hydrophobic treatment, average particle size: 0.05 μm, and amount added: 1.0 part by weight). The inorganic fine particles y are made of TiO₂ (silane coupling agent having its surface subjected to hydrophobic treatment, average particle size: 0.02 μm, refractive index: 2.5, and amount added: 1.0 part by weight).

Tt of the toner became 110 degrees.

100 parts by weight of a carrier the same as that of a black developing agent for Acolor635 (made by Fuji Xerox Co., Ltd.) and 8 parts by weight of the toner were mixed so that a two-component developing agent was produced.

Color Toner Developing Agents b:

A resin fine particle dispersion, a pigment dispersion, and a release agent particle dispersion were produced in the following method in advance.

| | | |
|---|---|---|
| Styrene | 340 | parts by weight |
| n-butyl Acrylate | 65 | parts by weight |
| Acrylic Acid | 6 | parts by weight |
| Dodecanediol | 6 | parts by weight |
| Carbon Tetrabromide | 4 | parts by weight |

A solution obtained by mixing these components, 6 parts by weight of a nonionic surface-active agent (NONIPOL 400 made by Sanyo Chemical Industries, Ltd.) and 10 parts by weight of an anionic surface-active agent (Neogene R made by Daiichi Pharmaceutical Co., Ltd.) were dissolved in 550 parts by weight of ion exchange water so as to prepare a solution. After being put into a flask, the prepared solution was dispersed and emulsified. While the solution was agitated and mixed for ten minutes, 50 parts by weight of ion exchange water containing 4 parts by weight of ammonium persulfate dissolved therein were put into the solution. After nitrogen was then substituted for the air inside the flask, the mixture was heated while agitated in an oil bath so that the temperature inside the system was 70° C. The mixture was polymerized as it is for five hours.

The volumetric average particle size (D50) of resin fine particles of a latex obtained thus were measured to be 200 nm by a laser diffraction type particle-size distribution measuring instrument (LA-700 made by Horiba, Ltd.). By a differential scanning calorimeter (DSC-50 made by Shimadzu Corp.) at a temperature increase rate of 10° C. pre minute, the glass transition point (Tg) of the resin was measured to be 60° C. By a molecular weight measuring instrument (HLC-8020 made by Tosoh Corp.) and with THF used as a solvent, the weight average molecular weight (polystyrene basis) of the resin was measured to be 33000.

Release Agent Fine Particle Dispersion (1)

Paraffin Wax (HNP0190 made by Nippon Seiro Co., Ltd., melting point: 85° C.) 50 parts by weight
Anionic Surface-Active Agent (Neogene R made by Daiichi Pharmaceutical Co., Ltd.) 3 parts by weight
Ion Exchange Water 150 parts by weight

After these components were well dispersed by a homogenizer (Ultra Turrax T50 made by IKA) while heated to 95° C., the mixture was moved to a pressure discharge type homogenizer and subjected to dispersion treatment. Thus, a release agent fine particle dispersion having release agent fine particles with a volumetric average particle size (D50) of 200 nm was obtained.

Pigment Dispersion (1)

Copper Phthalocyanine Pigment (made by BASF Corp.) 50 parts by weight
Anionic Surface-Active Agent (Neogene R made by Daiichi Pharmaceutical Co., Ltd.) 8 parts by weight
Ion Exchange Water 150 parts by weight

These components were dispersed for twenty minutes by an ultrasonic dispersion mill (W-113 made by Honda Motor Co., Ltd.). Thus, a blue pigment dispersion with a volumetric average particle size (D50) of 180 nm was obtained.

Pigment Dispersion (2)

Pigment Red 122 (made by Dainichiseika Color & Chemicals Mfg. Co., Ltd.) 50 parts by weight
Anionic Surface-Active Agent (Neogene RK made by Daiichi Pharmaceutical Co., Ltd.) 8 parts by weight
Ion Exchange Water 200 parts by weight

These components were dispersed for ten minutes by a homogenizer (Ultra Turrax T50 made by IKA) and further dispersed for thirty minutes by an ultrasonic dispersion mill (W-113 made by Honda Motor Co., Ltd.). Thus, a red pigment dispersion with a volumetric average particle size (D50) of 150 nm was obtained.

Pigment Dispersion (3)

Pigment Yellow 180 (made by Clariant Corp.) 50 parts by weight
Anionic Surface-Active Agent (Neogene RK made by Daiichi Pharmaceutical Co., Ltd.) 8 parts by weight
Ion Exchange Water 200 parts by weight

These components were dispersed for ten minutes by a homogenizer (Ultra Turrax T50 made by IKA) and further dispersed for thirty minutes by an ultrasonic dispersion mill (W-113 made by Honda Motor Co., Ltd.). Thus, a yellow pigment dispersion with a volumetric average particle size (D50) of 200 nm was obtained.

Pigment Dispersion (4)

Carbon Black (Mogul L made by Cabot Corp.) 50 parts by weight
Anionic Surface-Active Agent (Neogene RK made by Daiichi Pharmaceutical Co., Ltd.) 6 parts by weight
Ion Exchange Water 200 parts by weight

These components were dispersed for twenty minutes by an ultrasonic dispersion mill (W-113 made by Honda Motor Co., Ltd.). Thus, a black pigment dispersion with a volumetric average particle size (D50) of 200 nm was obtained.

Preparation of Coagulated Particles

Resin Fine Particle Dispersion (1) 260 parts by weight
Release Agent Dispersion (1) 40 parts by weight
Any One of Pigment Dispersions (1) to (4) 40 parts by weight
Poly Aluminum Chloride 3 part of weight

The components were put into a round stainless steel flask and well mixed and dispersed by a homogenizer (Ultra Turrax T50 made by IKA). Then, the mixture was heated to 50° C. by a heating oil bath while the flask was agitated. After the mixture was kept for thirty minutes at that temperature, the temperature of the heating oil bath was raised to 52° C. and then retained. Thus, coagulated particles were obtained. The volumetric average particle size (D50) of the coagulated particles was measured to be 5.0 μm by a Coulter Counter (TAII made by Nikkaki Bios Co., Ltd.) and the volumetric average particle size distribution (GSDv) of the coagulated particles was 1.24.

Deposition of Resin Fine Particles

70 parts by weight of the resin fine particle dispersion solution (1) were added moderately to the dispersion solution of the coagulated particles and directly agitated for thirty minutes while heated. Thus, resin fine particles were deposited onto the surfaces of the coagulated particles. The volumetric average particle size (D50) of the deposited particles was measured to be 5.5 μm and GSDv of the deposited particles was 1.23.

Fusion and Coalescence

Aqueous sodium hydroxide was added to the dispersion of the deposited particles so as to adjust the pH of the dispersion to 5.0. After the dispersion of the particles became stable, the dispersion was heated to 90° C. so that the particles were fused and coalesced by the heat.

Alkali Treatment

The dispersion of the fused and coalesced particles was cooled to 70° C. Then, sodium hydroxide was added to the dispersion of the fused and coalesced particles so as to adjust the pH of the dispersion to 10. The dispersion was then heated directly for one hour so as to remove the surface active agent.

Cleaning with First Pure Water

The dispersion of the fused and coalesced particles after alkali treatment was filtrated so as to remove the mother liquor. Then, the toner particles were cleaned with pure water having an amount six times as large as that of the toner particles, and then filtrated. This operation was performed three times. Conductance of a third time filtrate was measured to be 78 uS/cm. When the toner particles at that time were dried and measured by XPS, a sodium amount in the surfaces of the particles with respect to the total amount of carbon and oxygen was 1.3%.

Cleaning with Acid Solution

After the cleaning with the first pure water was completed, the particles were dispersed again in pure water having an amount six times as large as that of the particles, and nitric acid was added thereto so as to adjust the pH of the solution to 5. The resulting solution was then agitated and filtrated.

Cleaning with Second Pure Water

Further, the particles were dispersed in pure water having an amount six times as large as that of the particles. Then, the particles were cleaned, filtrated and dried. Thus, toner particles of four colors of color toner developing agents b were obtained.

The volumetric average particle size (D50) of the toner particles of each of the colors was measured to be 5.4 μm to 5.6 μm by a Coulter Counter. The volumetric average particle distribution coefficient (GSDv) of the toner particles was 1.23 to 1.25. By a differential scanning calorimeter (DSC-50 made by Shimadzu Corp.) at a temperature increase rate of 10° C. per minute, the glass transition point (Tg) of the toner was measured to be 57° C.

The following two kinds of inorganic fine particles x and y were deposited on 100 parts by weight of the toner particles by a high speed mixer.

The inorganic fine particles x are made of SiO₂ (silane coupling agent having its surface subjected to hydrophobic treatment, average particle size: 0.05 μm, and amount added: 1.5 parts by weight). The inorganic fine particles y are made of TiO₂ (silane coupling agent having its surface subjected to hydrophobic treatment, average particle size: 0.02 μm, refractive index: 2.5, and amount added: 1.5 parts by weight).

Tt of the toner became 110 degrees.

Seven parts by weight of color toners and 100 parts by weight of carriers the same as those of color developing agents for DocuCenter Color 500 (made by Fuji Xerox Co., Ltd.) were mixed so that two-component developing agents of cyan, magenta, yellow and black were produced.

Color Toner Developing Agents c:

Preparation of Resin Particle Dispersion (1)

150 parts of a crystalline polyester resin B and 15 parts of an anionic surface-active agent (Neogene RK made by Daiichi Pharmaceutical Co., Ltd.) were put in 850 parts of distilled water. While heated to 140° C., these components were mixed and agitated by a Clearmix (made by Organo Corp.). Thus, a resin particle dispersion (1) was obtained.

Preparation of Resin Particle Dispersion (2)

150 parts of an amorphous resin H and 15 parts of an anionic surface-active agent (Neogene RK made by Daiichi Pharmaceutical Co., Ltd.) were put in 850 parts of distilled water. While heated to 140° C., these components were mixed and agitated by a Clearmix (made by Organo Corp.). Thus, a resin particle dispersion (2) was obtained.

Preparation of Colorant Dispersion (1)

250 parts of cyan pigment (ECB-301 made by Dainichiseika Color & Chemicals Mfg. Co., Ltd.), 20 parts of an anionic surface-active agent (Neogene RK made by Daiichi Pharmaceutical Co., Ltd.), and 730 parts of ion exchange water were mixed and dissolved. Then, these components were dispersed by a homogenizer (Ultra Turrax T50 made by IKA). Thus, a colorant dispersion (1) containing a colorant (cyan pigment) dispersed therein was obtained.

Preparation of Colorant Dispersion (2)

250 parts of magenta pigment (ECR-186Y made by Dainichiseika Color & Chemicals Mfg. Co., Ltd.), 20 parts of an anionic surface-active agent (Neogene RK made by Daiichi Pharmaceutical Co., Ltd.), and 730 parts of ion exchange water were mixed, dissolved and dispersed in the same method as that for the colorant dispersion (1). Thus, a colorant dispersion (2) containing a colorant (magenta pigment) dispersed therein was obtained.

Preparation of Colorant Dispersion (3)

250 parts of yellow pigment (Hansa Brill. Yellow 5GX03 made by Clariant (Japan) K.K.), 20 parts of an anionic surface-active agent (Neogene RK made by Daiichi Pharmaceutical Co., Ltd.), and 730 parts of ion exchange water were mixed, dissolved and dispersed in the same method as that for the colorant dispersion (1). Thus, a colorant dispersion (3) containing a colorant (yellow pigment) dispersed therein was obtained.

Preparation of Colorant Dispersion (4)

250 parts of carbon black (Regal 330 made by Cabot Corp.), 20 parts of an anionic surface-active agent (Neogene RK made by Daiichi Pharmaceutical Co., Ltd.), and 730 parts of ion exchange water were mixed, dissolved and dispersed in the same method as that for the colorant dispersion (1). Thus, a colorant dispersion (4) containing a colorant (carbon black) dispersed therein was obtained.

Preparation of Release Agent Dispersion

350 parts of a release agent (Rikemal B-200 made by Riken Vitamin Co., Ltd., melting point: 68° C.), 15 parts of an anionic surface-active agent (Neogene RK made by Daiichi Pharmaceutical Co., Ltd.), and 635 parts of ion exchange water were mixed and dispersed by a homogenizer (Ultra Turrax T50 made by IKA,) while heated to 90° C. on a water bath. Thus, a release agent dispersion was prepared.

Preparation of Electrophotographic Toner

800 parts of the resin particle dispersion (1), 800 parts of the resin particle dispersion (2), 52 parts of any one of the colorant dispersions (1) to (4), 66 parts of the release agent dispersion, 5 parts of calcium chloride (made by Wako Pure Chemical Industries, Ltd.), and 100 parts of ion exchange water were received in a round stainless steel flask and adjusted to be 4.0 in terms of pH. After dispersed by a homogenizer (Ultra Turrax T50 made by IKA), these components were then heated to 65° C. in a heating oil bath while agitated. When the mixture which had been kept for three hours at 65° C. was observed by an optical microscope, it was confirmed that coagulated particles having an average particle size of about 5.0 μm were formed.

When the mixture which had been heated at 65° C. and agitated for another one hour was observed by an optical microscope, it was confirmed that coagulated particles having an average particle size of about 5.5 μm were formed.

The pH of the coagulated particle dispersion was 3.8. Then, an aqueous solution containing sodium carbonate (made by Wako Pure Chemical Industries, Ltd.) diluted to be 0.5% by weight was moderately added to the coagulated particle dispersion so that the pH of the coagulated particle dispersion was adjusted to 5.0. While the dispersion of the coagulated particles was agitated continuously, the temperature was raised to 80° C. and kept for thirty minutes. When the coagulated particle dispersion was observed by an optical microscope, coalesced spherical particles were observed. Then, the temperature was reduced to 30° C. at a rate of 10° C. per minute while ion exchange water was added to the coagulated particle dispersion. Thus, the particles were solidified.

After a reaction product was then filtrated and well cleaned with ion exchange water, the reaction product was dried by a vacuum drier. Thus, electrophotographic toner particles were obtained.

When the obtained toner particles were measured by a Coulter Counter [TA-II] type (aperture diameter: 50 μm, made by Coulter Corp.), the volumetric average particle size was 5.5 μm and the number average particle size was 4.6 μm. When each of these particles was observed by an optical microscope, the shape of the particle was spherical.

0.8 wt % of the silica fine particles (hydrophobic silica made by Nippon Aerosil Co., Ltd.: RX50) having an average primary particle size of 40 nm and having a surface subjected to hydrophobic treatment, and 1.0 wt % of metatitanic compound fine particles which had an average primary particle size of 20 nm and which were reaction products obtained by processing 40 parts by weight of isobutyl trimethoxy silane and 10 parts by weight of trifluoro propyl trimethoxy silane with respect to 100 parts by weight of metatitanic acid were added to electrophotographic toners and mixed for five minutes by a Henschel mixer. Then, the mixture was shifted by a 45 μm sieve mesh. Thus, electrophotographic toner was produced.

Tt of the toner became 80 degrees.

7 parts by weight of the toners and 100 parts by weight of carriers the same as those of color developing agents for DocuCenter Color 500 (made by Fuji Xerox Co., Ltd.) were mixed so that two-component developing agents of cyan, magenta, yellow and black were produced.

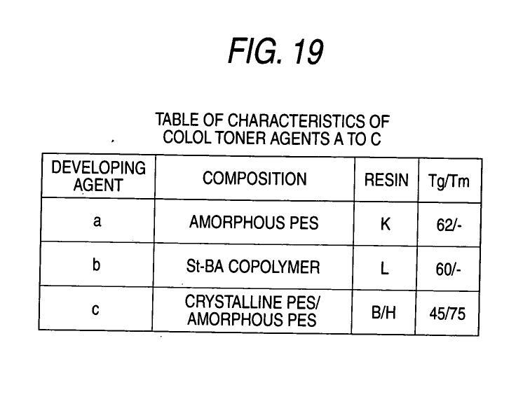

FIG. 19 shows a table of characteristics of the produced color toner developing agents a to c. In FIG. 19, PES is an abbreviation for polyester and St-BA is an abbreviation for styrene-n-butyl acrylate.

### Example 1

[Toner Image Generating Apparatus]

The color image forming apparatus shown in FIGS. 2A and 2B was used as a toner image generating apparatus. Speed of an image forming process except a fixing step was 160 mm/s. A weight ratio between toners and carriers, charging potential of a photoconductor, an exposure amount and a development bias were adjusted so that a development amount of color toner in a solid image portion was 0.5 (mg/cm²) each color.

[Color Toner Developing Agents]

The color toner developing agents a were used.

[Adhesive Layer Forming Toner Developing Agent]

Preparation of Resin Particle Dispersion (1)

150 parts of a crystalline polyester resin A and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 140° C. Thus, a resin particle dispersion (1) was obtained.

Preparation of Resin Particle Dispersion (2)

150 parts of an amorphous resin M and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 140° C. Thus, a resin particle dispersion (2) was obtained.

Preparation of Release Agent Dispersion

350 parts of a release agent (Rikemal B-200 made by Riken Vitamin Co., Ltd., melting point: 68° C.), 15 parts of an anionic surface-active agent (Neogene RK made by Daiichi Pharmaceutical Co., Ltd.), and 635 parts of ion exchange water were mixed, and dispersed by a homogenizer (Ultra Turrax T50 made by IKA) while heated to 90° C. on a water bath. Thus, a release agent dispersion was prepared.

Preparation of Electrophotographic Toner

800 parts of the resin particle dispersion (1), 800 parts of the resin particle dispersion (2), 66 parts of the release agent dispersion, 5 parts of calcium chloride (made by Wako Pure Chemical Industries, Ltd.), and 100 parts of ion exchange water were received in a round stainless steel flask and adjusted to be 4.0 in terms of pH. After dispersed by a homogenizer (Ultra Turrax T50 made by IKA), these components were then heated to 65° C. in a heating oil bath while agitated. When the mixture which had been kept for three hours at 65° C. was observed by an optical microscope, it was confirmed that coagulated particles having an average particle size of about 5.0 μm were formed.

When the mixture which had been heated at 65° C. and agitated for another one hour was observed by an optical microscope, it was confirmed that coagulated particles having an average particle size of about 5.5 μm were formed.

The pH of the coagulated particle dispersion was 3.8. Then, an aqueous solution containing sodium carbonate (made by Wako Pure Chemical Industries, Ltd.) diluted to be 0.5% by weight was moderately added to the coagulated particle dispersion so that the pH of the coagulated particle dispersion was adjusted to 5.0. While the dispersion of the coagulated particles was agitated continuously, the temperature was raised to 80° C. and retained for thirty minutes. When the coagulated particle dispersion was observed by an optical microscope, coalesced spherical particles were observed. Then, the temperature was reduced to 30° C. at a rate of 10° C. per minute while ion exchange water was added to the coagulated particle dispersion. Thus, the particles were solidified.

After a reaction product was then filtrated and well cleaned with ion exchange water, the reaction product was dried by a vacuum drier. Thus, electrophotographic toner particles were obtained.

When the obtained particles were measured by a Coulter Counter [TA-II] type (aperture diameter: 50 μm, made by Coulter Corp.), the volumetric average particle size was 5.5 μm. When each of these particles was observed by an optical microscope, the shape of the particle was spherical.

0.8 wt % of silica fine particles (hydrophobic silica made by Nippon Aerosil Co., Ltd.: RX50) having an average primary particle size of 40 nm and having a surface subjected to hydrophobic treatment, and 1.0 wt % of metatitanic compound fine particles which had an average primary particle size of 20 nm and which were reaction products obtained by processing 40 parts by weight of isobutyl trimethoxy silane and 10 parts by weight of trifluoro propyl trimethoxy silane with respect to 100 parts by weight of metatitanic acid were added to electrophotographic toners and mixed for five minutes by a Henschel mixer. Then, the mixture was shifted by a 45 μm sieve mesh. Thus, electrophotographic toner was produced.

Tt of the toner became 75 degrees.

7 parts by weight of the toners and 100 parts by weight of carriers the same as those of color developing agents for DocuCenter Color 500 (made by Fuji Xerox Co., Ltd.) were mixed so that two-component developing agents of cyan, magenta, yellow and black were produced.

[Image Support]

A sheet of mirror coat gold paper (made by Oji Paper Co., Ltd.) of GSM having an areal weight of 157 was used as an image support.

[Fixing Device]

A material formed by applying a thickness of 50 μm of KE4895 silicon rubber (made by Shin-Etsu Chemical Co., Ltd.) to a polyimide film containing electrically conductive carbon dispersed therein and having a thickness of 80 μm is used as a base material of a fixing belt.

A roll formed by providing a silicon rubber layer 2 mm thick on a core material of aluminium was used as each of two heating rolls. A halogen lamp was disposed as a heat source in the center of each of the two heating rolls. The temperature of the surface of each of the rolls was changed from 90° C. to 150° C.

The fixing rate was set at 30 mm/sec.

The temperature of the image support in the separation position was 60° C.

[Image Generating Procedure]

By use of the aforementioned device, an image in which portrait photograph toner images (normal toner images) and an adhesive toner image serving as a repeelable adhesive layer had been fixed was output.

Further, by use of the folding mechanism 90 of the post-process unit 23, the image was folded into two from the center so that the folded parts of the repeelable adhesive layer on the image support were superposed on each other and inserted into a heating portion of the adhesion device 100 shown in FIG. 7. The speed of the surface of the adhesion roll was set at 30 mm/sec and the adhesion temperature (highest temperature for the adhesive layer to reach in the adhesion device) was changed in the range of from 50° C. to 120° C. The parts of the repeelable adhesive layer were bonded to each other. On this occasion, the toner image portion serving as the repeelable adhesive layer was produced to be smaller by about 1 mm from each side of the image support than the size of the image support. A developing amount of the toner image as the adhesive layer per unit area was adjusted to be 15 g/m².

[Evaluation of Toner Material]

Here, the toner material used was evaluated as follows.

The molecular weight was measured by gel permeation chromatography. Tetrahydrofuran was used as the solvent.

The mean particle size of the toner was measured by a Coulter Counter and expressed as a weight average d50.

Incidentally, viscosity of the resin was measured by a rotary plate rheometer (RDAII made by Rheometric Scientific, Inc.) with an angular speed of 1 rad/sec.

[Measurement of Luminous Reflectance Y]

The luminous reflectance Y was measured in the following procedure (see FIG. 4).

Toner particles of the adhesive toner image serving as a repeelable adhesive layer were developed on a color OHP sheet (made by Fuji Xerox Co., Ltd.) with a thickness equal to that of a normal toner image serving as a repeelable adhesive layer so that a transparent image was generated.

Cover glasses for microscope observation were superposed on the front and rear surfaces of the transparent image and gaps between the image and the cover glasses were filled with tetradecane.

The color of the resulting image put on a light trap was measured by an X-rite 968 so as to measure Y′.

Cover glasses for microscope observation were superposed on the front and rear surfaces of an OHP sheet having no thermoplastic resin applied thereon, and gaps between the image and the cover glasses were filled with tetradecane. In the same procedure, Y₀ was measured.

Y is obtained by subtracting Y₀ from Y′.

### Example 2

A color image was generated in the same manner as in Example 1 except that the resins of the toner forming the adhesive layer were changed to another two kinds of resins, that is, a crystalline polyester resin B and an amorphous resin N.

Preparation of Resin Particle Dispersion (1)

150 parts of a crystalline polyester resin B and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 140° C. Thus, a resin particle dispersion (1) was obtained.

Preparation of Resin Particle Dispersion (2)

150 parts of an amorphous resin N and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 140° C. Thus, a resin particle dispersion (2) was obtained.

In the toner forming the adhesive layer, a volumetric average particle size was 5.5 μm and Tm was 78° C.

### Example 3

A color image was generated in the same manner as in Example 1 except that the resins of the toner forming the adhesive layer were changed to another two kinds of resins, that is, a crystalline polyester resin C and an amorphous resin M and the color toner developing agents were changed to color toner developing agents b.

Preparation of Resin Particle Dispersion (1)

150 parts of a crystalline polyester resin C and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 140° C. Thus, a resin particle dispersion (1) was obtained.

Preparation of Resin Particle Dispersion (2)

150 parts of an amorphous resin M and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 140° C. Thus, a resin particle dispersion (2) was obtained.

In the toner forming the adhesive layer, a volumetric average particle size was 6.0 μm and Tm was 75° C.

### Example 4

A color image was generated in the same manner as in Example 1 except that the resins of the toner forming the adhesive layer were changed to another two kinds of resins, that is, a crystalline polyester resin B and an amorphous resin M and the color toner developing agents were changed to color toner developing agents b.

Preparation of Resin Particle Dispersion (1)

150 parts of a crystalline polyester resin B and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 140° C. Thus, a resin particle dispersion (1) was obtained.

Preparation of Resin Particle Dispersion (2)

150 parts of an amorphous resin M and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 140° C. Thus, a resin particle dispersion (2) was obtained.

In the toner forming the adhesive layer, a volumetric average particle size was 6.0 μm and Tm was 76° C.

### Example 5

A color image was generated in the same manner as in Example 1 except that the resins of the toner forming the adhesive layer were changed to another two kinds of resins, that is, a crystalline polyester resin B and an amorphous resin Q and the color toner developing agents were changed to color toner developing agents b.

Preparation of Resin Particle Dispersion (1)

150 parts of a crystalline polyester resin B and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 140° C. Thus, a resin particle dispersion (1) was obtained.

Preparation of Resin Particle Dispersion (2)

150 parts of an amorphous resin Q and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 100° C. Thus, a resin particle dispersion (2) was obtained.

In the toner forming the adhesive layer, a volumetric average particle size was 6.0 μm and Tm was 80° C.

### Example 6

A color image was generated in the same manner as in Example 1 except that the resins of the toner forming the adhesive layer were changed to another two kinds of resins, that is, a crystalline polyester resin H and an amorphous resin M and the color toner developing agents were changed to color toner developing agents b.

Preparation of Resin Particle Dispersion (1)

150 parts of a crystalline polyester resin H and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 140° C. Thus, a resin particle dispersion (1) was obtained.

Preparation of Resin Particle Dispersion (2)

150 parts of an amorphous resin M and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 100° C. Thus, a resin particle dispersion (2) was obtained.

In the toner forming the adhesive layer, a volumetric average particle size was 6.5 μm and Tm was 94° C.

### Example 7

A color image was generated in the same manner as in Example 1 except that the resins of the toner forming the adhesive layer were changed to another two kinds of resins, that is, a crystalline polyester resin I and an amorphous resin N and the color toner developing agents were changed to color toner developing agents b.

Preparation of Resin Particle Dispersion (1)

150 parts of a crystalline polyester resin 1 and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 140° C. Thus, a resin particle dispersion (1) was obtained.

Preparation of Resin Particle Dispersion (2)

150 parts of an amorphous resin N and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 100° C. Thus, a resin particle dispersion (2) was obtained.

In the toner forming the adhesive layer, a volumetric average particle size was 5.5 μm and Tm was 93° C.

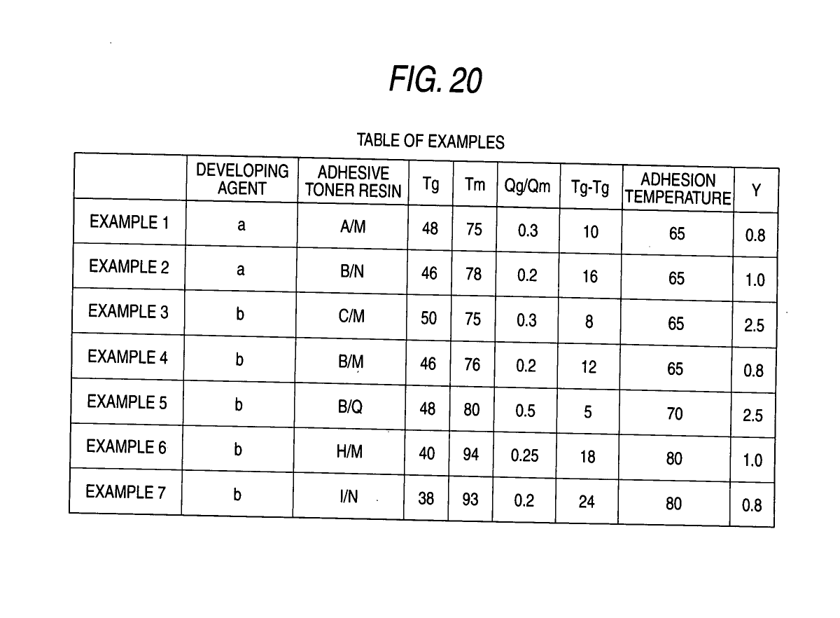

Here, FIG. 20 shows a table of Examples 1 to 7.

### Comparative Example 1

A color image was generated in the same manner as in Example 1 except that the resins of the toner forming the adhesive layer were changed to one kind of resin, that is, an amorphous resin P.

Preparation of Resin Particle Dispersion (1)

150 parts of an amorphous resin P and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 140° C. Thus, a resin particle dispersion (1) was obtained.

In the toner forming the adhesive layer, a volumetric average particle size was 6.0 μm and Tm was 105° C.

### Comparative Example 2

A color image was generated in the same manner as in Example 1 except that the resins of the toner forming the adhesive layer were changed to one kind of resin, that is, an amorphous resin M.

Preparation of Resin Particle Dispersion (1)

150 parts of an amorphous resin M and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 140° C. Thus, a resin particle dispersion (1) was obtained.

In the toner forming the adhesive layer, a volumetric average particle size was 5.5 μm and Tm was 115° C.

### Comparative Example 3

A color image was generated in the same manner as in Example 1 except that the resins of the toner forming the adhesive layer were changed to another two kinds of resins, that is, a crystalline polyester resin F and an amorphous resin O and the color toner developing agents were changed to color toner developing agents b.

Preparation of Resin Particle Dispersion (1)

150 parts of a crystalline polyester resin F and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 140° C. Thus, a resin particle dispersion (1) was obtained.

Preparation of Resin Particle Dispersion (2)

150 parts of an amorphous resin 0 and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 100° C. Thus, a resin particle dispersion (2) was obtained.

In the toner forming the adhesive layer, a volumetric average particle size was 6.5 μm and Tm was 110° C.

### Comparative Example 4

A color image was generated in the same manner as in Example 1 except that the resins of the toner forming the adhesive layer were changed to another two kinds of resins, that is, a crystalline polyester resin G and an amorphous resin O and the color toner developing agents were changed to color toner developing agents c.

Preparation of Resin Particle Dispersion (1)

150 parts of a crystalline polyester resin G and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 140° C. Thus, a resin particle dispersion (1) was obtained.

Preparation of Resin Particle Dispersion (2)

150 parts of an amorphous resin 0 and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 100° C. Thus, a resin particle dispersion (2) was obtained.

In the toner forming the adhesive layer, a volumetric average particle size was 5.5 μm and Tm was 90° C.

### Comparative Example 3

A color image was generated in the same manner as in Example 1 except that the resins of the toner forming the adhesive layer were changed to one kind of resin, that is, a crystalline polyester resin B and the color toner developing agents were changed to color toner developing agents c.

Preparation of Resin Particle Dispersion (1)

150 parts of a crystalline polyester resin B and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 140° C. Thus, a resin particle dispersion (1) was obtained.

In the toner forming the adhesive layer, a volumetric average particle size was 6.5 μm and Tm was 76° C.

### Comparative Example 6

A color image was generated in the same manner as in Example 1 except that the resins of the toner forming the adhesive layer were changed to another two kinds of resins, that is, a crystalline polyester resin G and an amorphous resin O and the color toner developing agents were changed to color toner developing agents b.

Preparation of Resin Particle Dispersion (1)

150 parts of a crystalline polyester resin G and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 140° C. Thus, a resin particle dispersion (1) was obtained.

Preparation of Resin Particle Dispersion (2)

150 parts of an amorphous resin 0 and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 140° C. Thus, a resin particle dispersion (2) was obtained.

In the toner forming the adhesive layer, a volumetric average particle size was 5.5 μm and Tm was 90° C.

### Comparative Example 7

A color image was generated in the same manner as in Example 1 except that the resins of the toner forming the adhesive layer were changed to another two kinds of resins, that is, a crystalline polyester resin E and an amorphous resin P and the color toner developing agents were changed to color toner developing agents b.

Preparation of Resin Particle Dispersion (1)

150 parts of a crystalline polyester resin E and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 140° C. Thus, a resin particle dispersion (1) was obtained.

Preparation of Resin Particle Dispersion (2)

150 parts of an amorphous resin P and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 100° C. Thus, a resin particle dispersion (2) was obtained.

In the toner forming the adhesive layer, a volumetric average particle size was 6.0 μm and Tm was 78° C.

### Comparative Example 8

A color image was generated in the same manner as in Example 1 except that the resins of the toner forming the adhesive layer were changed to one kind of resin, that is, a crystalline polyester resin J and the color toner developing agents were changed to color toner developing agents b.

Preparation of Resin Particle Dispersion (1)

150 parts of a crystalline polyester resin J and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 140° C. Thus, a resin particle dispersion (1) was obtained.

In the toner forming the adhesive layer, a volumetric average particle size was 5.5 μm and Tm was 91° C.

### Comparative Example 9

A color image was generated in the same manner as in Example 1 except that the resins of the toner forming the adhesive layer were changed to one kind of resin, that is, a crystalline polyester resin B and the color toner developing agents were changed to color toner developing agents b.

Preparation of Resin Particle Dispersion (1)

150 parts of a crystalline polyester resin B and 15 parts of an anionic surface-active agent (Neogene RK made by Daiichi Pharmaceutical Co., Ltd.) were put in 850 parts of distilled water, and then mixed and agitated by a Clearmix (made by Organo Corp.) while heated to 140° C. Thus, a resin particle dispersion (1) was obtained.

In the toner forming the adhesive layer, a volumetric average particle size was 6.5 μm and Tm was 76° C.

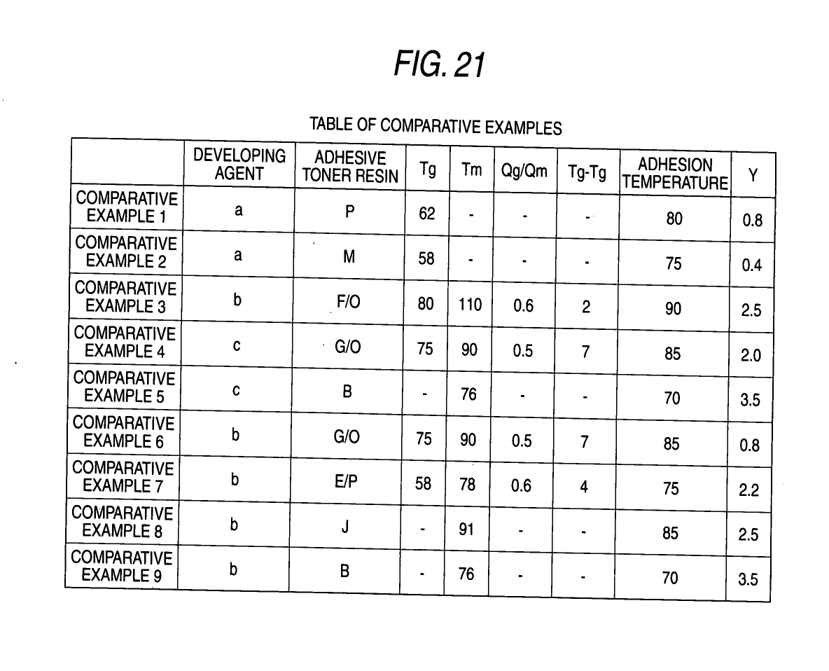

Here, FIG. 21 shows a table of Comparative Examples 1 to 9.

(Image Evaluation)

Mechanical Strength

Each of the image supports obtained in the Examples and the Comparative Examples was wound on metal rolls different in radius so that a minimum radium which would cause no crack in the image support was examined. Evaluation was made based on the radium. The mechanical strength was evaluated as “◯” in the case where the radium was smaller than 10 mm, “Δ” in the case where the radium was not smaller than 10 mm but smaller than 40 mm, and “X” in the case where the radium was not smaller than 40 mm.

Heat Resistance

In the condition that the front and rear surfaces of each of the images (before adhesion) obtained in the Examples and the Comparative Examples were laminated on each other while brought into contact with each other, and a weight of 30 g/cm² was added to the front and rear surfaces of the image, the image was put on a constant temperature layer retained at a constant temperature and kept for three days. After passage of three days, the image was brought back to room temperature of about 22° C. and the front and rear surfaces of the image were released from each other. This test was repeated while the temperature was varied. Evaluation was made based on the temperature at which the surface of the image was destroyed. The heat resistance was evaluated as “◯” in the case where the temperature was not lower than 55° C., “Δ” in the case where the temperature was not lower than 40° C. but lower than 55° C., and “X” in the case where the temperature was not higher than 40° C.

Low Temperature Fixability

Evaluation of Fixing Temperature

Each of the images obtained in the Examples and the Comparative Examples was folded into parts while the image surface was on the inner side. A copper solid roll with a diameter of 50 mm was rolled on the folded image. Evaluation was made based on the surface temperature of the fixing roll at which the defective width of the toner image on this occasion was not larger than 1 mm. The fixing temperature was evaluated as “◯” in the case where the surface temperature of the fixing roll was lower than 110° C., “Δ” in the case where the surface temperature of the fixing roll was not lower than 110° C. but lower than 150° C., and “X” in the case where the surface temperature of the fixing roll was not lower than 150C.

Solidification Speed

Solidification speed was evaluated as follows.

Evaluation was made based on the solidification state of each of the output images after ten minutes had passed since the image was cooled and separated from the fixing device. The solidification speed was evaluated as “◯” in the case where the adhesive layer was completely solid and no finger print etc. would be left even if the adhesive layer was touched by hand, “Δ” in the case where there was no problem in smoothness of the surface of the image when another output image was laminated on the image, although the adhesive layer was not completely solid and finger print would be left slightly, and “X” in the case where the adhesive layer was not completely solid, the surface of the image was not smooth, unevenness in glossness was generated and the image could not be separated from the belt but stuck to the belt even if the image had passed through the separating roll.

General Image Quality

General quality of each of the images obtained in the Examples and the Comparative Examples and in the condition that the fixing temperature (highest temperature for the adhesive layer to reach in the fixing process) was Tm+10° C. was evaluated in accordance with the following five categories.
Very Good: 5 points
Good: 4 points
Normal: 3 pints
Not Good: 2 points
Very Poor: 1 point

There were ten testees and evaluation was made based on an average point of the 10 testees' points.

The general image quality was evaluated as “◯” in the case where the average point was not lower than 3.5 points, “Δ” in the case where the average point was not lower than 2.5 points but lower than 3.5 points, and “X” in the case where the average point was lower than 2.5 points.

Adhesionable Temperature

Each of the adhesive images obtained in the Examples and the Comparative Examples was wound on metal rolls different in radius so that a minimum radium which would cause no peeling of the adhesive layer was examined. Evaluation was made based on the adhesion temperature when the radium was 20 mm. The adhesionable temperature was evaluated as “◯” in the case where the adhesion temperature was lower than 70° C., “Δ” in the case where the adhesion temperature was not lower than 70° C. but lower than 85° C., and “X” in the case where the adhesion temperature was not lower than 85° C.

Evaluation of Releasbility

Evaluation of Repeelable Temperature

An adhesive layer of Scotch mending tape was laminated on the rear surface of each of the images (images after adhesion) obtained in the Examples and the Comparative Examples. After a copper solid roll with a diameter of 50 mm was rolled on the laminate of the tape and the image, the tape was released from the end portion. Evaluation was made based on the highest temperature for the adhesive layer to reach in the adhesion device when the repeelable adhesive layers could be repeelable from each other on this occasion, and there was no defect in the toner image itself but some damage was found in the adhesive layer. The repeelable temperature was evaluated as “◯” in the case where the highest temperature for the adhesive layer to reach was not lower than 80° C., “Δ” in the case where the highest temperature for the adhesive layer to reach was not lower than 70° C. but lower than 80° C., and “X” in the case where the highest temperature for the adhesive layer to reach was lower than 70° C.

Adhesion Temperature Range

Evaluation of Latitude between Adhesion and Release

Evaluation was made based on the range between an adhesionable temperature and a repeelable temperature of the repeelable adhesive layer of each of the images (images after adhesion process) obtained in the Examples and the Comparative Examples. The adhesionable temperature is a temperature at which the repeelable adhesive layer of the image was not peeled off even when wound on a roll with a diameter of 20 mm. The latitude between adhesion and release was evaluated as “◯” in the case where the range between the adhesionable temperature and the repeelable temperature was not smaller than 20° C., “Δ” in the case where the range between the adhesionable temperature and the repeelable temperature was not smaller than 5° C. but smaller than 20° C., and “X” in the case where the range between the adhesion temperature and the repeelable temperature was not larger than 5° C.

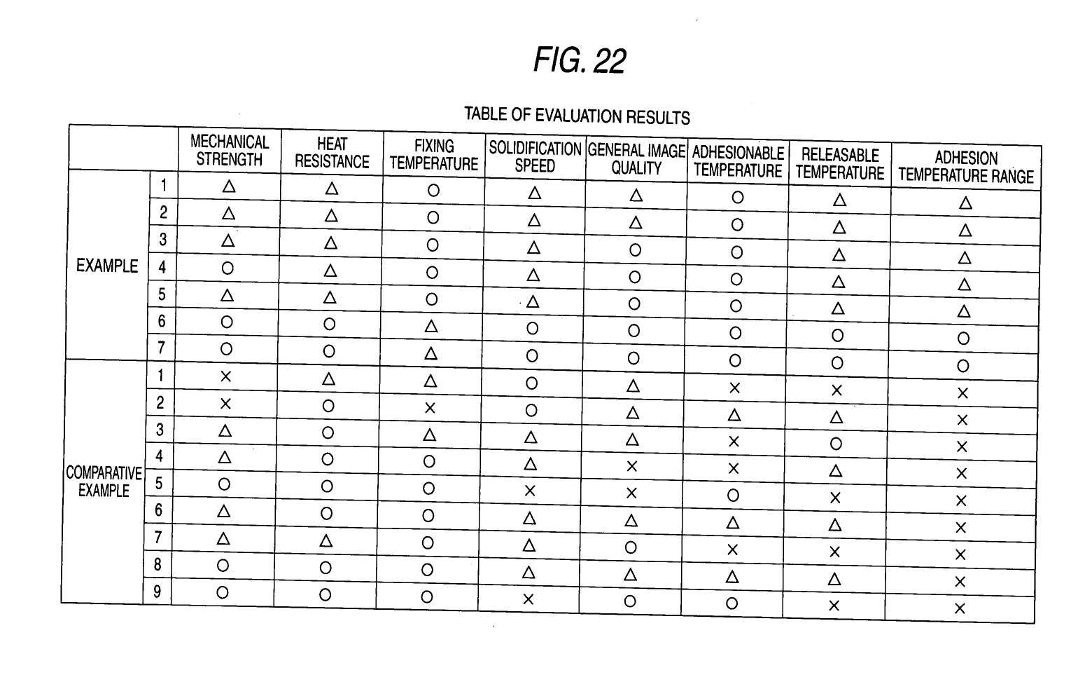

FIG. 22 shows a table of evaluation results on the images.

According to FIG. 22, Embodiments 1 to 7 could obtain images satisfying all the image requirements (mechanical strength, heat resistance, fixing temperature, solidification speed, adhesionable temperature, repeelable temperature and temperature range).

On the other hand, Comparative Examples 1 to 9 could not obtain satisfactory images satisfying at least one of the image requirements.

What is claimed is:

1. An image structure comprising:
a normal toner image formed on an image support and comprising toner particles; and
an adhesive toner image formed on or around the normal toner image, serving as a repeelable adhesive layer and comprising toner particles,
wherein the toner particles of the adhesive toner image have a glass transition point Tg in a range of from 30° C. to 50° C. and a melting point Tm in a range of from 70° C. to 110° C.

2. The image structure according to claim 1, wherein the toner particles of the adhesive toner image comprises a thermoplastic resin, and the thermoplastic resin has an endothermic quantity of heat Qg based on the glass transition point Tg in the range of from 30° C. to 50° C. and an endothermic quantity of heat Qm based on the melting point Tm in the range of from 70° C. to 110° C. in accordance with differential thermogravimetric analysis; and
Qg and Qm satisfy the relation 0.1<Qg/Qm<0.4.

3. The image structure according to claim 1, wherein the toner particles of the adhesive toner image comprises a thermoplastic resin containing a crystalline polyester resin and an amorphous resin, and the glass transition point Tg is lower by at least 10° C. than a glass transition point Tg′ of the amorphous resin.

4. The image structure according to claim 3, wherein a ratio by weight of the crystalline polyester resin to the amorphous resin is in a range of from 35:65 to 65:35.

5. A method of producing a toner particles of an adhesive toner image formed on or around a normal toner image on an image support, the toner particles including a thermoplastic resin, wherein the method comprising:
melting and mixing a crystalline polyester resin and an amorphous resin to produce the thermoplastic resin,
wherein the adhesive toner image serves as a repeelable adhesive layer,
the toner particles of the adhesive toner image have a glass transition point Tg in a range of from 30° C. to 50° C. and a melting point Tm in a range of from 70° C. to 110° C., and
the glass transition point Tg is lower by at least 10° C. than a glass transition point Tg′ of the amorphous resin.

6. The method of producing the toner particles according to 5, wherein T (° C.) is selected to be in a range of from T₀ to T₀+20, and t (minutes) is selected to be in a range of t₀ to 10×t₀,
where T₀ (° C.) is a temperature at which a luminous reflectance Y of a 20 μm-thick film is 1.5% when the film is formed from a resin obtained by melting and mixing the crystalline polyester resin and the amorphous resin for time t₀ (minutes), T (° C.) is a temperature at which the crystalline polyester resin and the amorphous resin are melted and mixed, and t (minutes) is the time during which the crystalline polyester resin and the amorphous resin are melted and mixed.

7. A method of producing a toner particles of an adhesive toner image formed on or around a normal toner image formed on an image support, comprising:
emulsifying a crystalline polyester resin to obtain the crystalline polyester resin emulsion particles, emulsifying an amorphous resin to obtain the amorphous resin emulsion particles, coagulating and coalescing the crystalline polyester resin emulsion particles and the amorphous emulsion particles to produce the toner particles of the adhesive toner image, wherein
the adhesive toner image serves as a repeelable adhesive layer,
the toner particles of the adhesive toner image have a glass transition point Tg in a range of from 30° C. to 50° C. and a melting point Tm in a range of from 70° C. to 110° C., and
the glass transition point Tg is lower by at least 10° C. than a glass transition point Tg′ of the amorphous resin.

8. The image structure according to claim 1, wherein:
the toner particles of the adhesive toner image contain 5% to 30% by weight of at least one of inorganic fine particles and organic fine particles based on the total weight of the toner particles of the adhesive toner image.

9. An image structure according to claim 1, wherein:
the toner particles of the normal toner image have a viscosity in a range of from 10³ Pa·s to 10 Pa·s at a fixing temperature; and
the toner particles of the adhesive toner image have a viscosity not higher than 10³ Pa·s at the fixing temperature.

10. The image structure according to claim 3, wherein the amorphous resin contains at least 80% by weight of a copolymer of a styrene based resin and an acrylic based resin based on the total weight of the amorphous resin.

11. An image structure according to claim 3, wherein the amorphous resin contains at least 80% by weight of a polyester based resin based on the total amorphous resin.

12. An image structure according to claim 11, wherein the crystalline polyester resin and the amorphous resin contain at least one of a common alcohol-derived component or a common acid-derived component.

13. The image structure according to claim 12, wherein the alcohol-derived component of the amorphous polyester resin contains a straight-chain aliphatic which has six to twelve carbon atoms and which is a main component of an alcohol-derived component of the crystalline polyester resin, and the content ratio of the straight-chain aliphatic to the whole alcohol-derived component in the amorphous polyester resin is in a range of from 10 mol % to 30 mol %, and
the acid-derived component of the amorphous polyester resin contains an aromatic component selected from terephthalic acid, isophthalic acid and naphthalene dicarboxylic acid, and the content ratio of the aromatic to the whole acid-derived component in the amorphous polyester resin is not smaller than 90 mol %.

14. The image structure according to claim 12, wherein
the alcohol-derived component of the crystalline polyester resin contains a straight-chain aliphatic having six to twelve carbon atoms and an aromatic diol, the content ratio of the straight-chain aliphatic to the whole alcohol-derived component in the crystalline polyester resin is in a range of from 85 mol % to 98 mol %, and the content ratio of the aromatic diolto the whole alcohol-derived component in the crystalline polyester resin is in a range of from 2 mol % to 15 mol %, and
the alcohol-derived component of the amorphous polyester resin contains the straight-chain aliphatic and the aromatic diol which is a main component of the alcohol-derived component of the crystalline polyester resin, the content ratio of the straight-chain aliphatic to the whole alcohol-derived component in the amorphous polyester resin is in a range of from 10 mol % to 30 mol %, and the content ratio of the aromatic diol to the whole alcohol-derived component in the amorphous polyester resin is in a range of from 70 mol % to 90 mol %.

15. An image structure according to claim 3, wherein
a weight average molecular weight of the crystalline polyester resin is in a range of from 17000 to 30000, and
a weight average molecular weight of the amorphous resin is in a range of from 8000 to 30000.

16. A recording medium comprising:
an image support; and
an image structure comprising:
a normal toner image formed on an image support and comprising toner particles; and
an adhesive toner image formed on or around the normal toner image, serving as a repeelable adhesive layer and comprising toner particles, wherein the toner particles of the adhesive toner image have a glass transition point Tg in a range of from 30° C. to 50° C. and a melting point Tm in a range of from 70° C. to 110° C.

17. The recording medium according to claim 16, wherein:
the image support is folded repeelably through the adhesive toner image.

18. An image forming apparatus for forming an image structure comprising a normal toner image formed on an image support and comprising toner particles; and an adhesive toner image formed on or around the normal toner image, serving as a repeelable adhesive layer and comprising toner particles, comprising:
a normal image generating unit for forming the normal toner image on the image support; and
an adhesive image generating unit for forming the adhesive toner image on or around the normal toner image on the image support,
wherein the toner particles of the adhesive toner image have a glass transition point Tg in a range of from 30° C. to 50° C. and a melting point Tm in a range of from 70° C. to 110° C.,

19. The image forming apparatus according to claim 18, wherein the normal image generating unit and the adhesive image generating unit include a fixing device for fixing the normal toner image and the adhesive toner image on the image support.

20. An image forming apparatus according to claim 19, wherein the fixing device includes:
a fixing member brought into close contact with the normal toner image and the adhesive toner image on the image support while the normal toner image and the adhesive toner image on the image support are nipped;
a heating and pressing unit for heating and pressing the normal toner image and the adhesive toner image on the image support using a heating roll and a pressing roll; and
a cooling and separating unit for cooling the heated and pressed normal toner image and adhesive toner image and separating the normal toner image and the adhesive toner image on the image support from the fixing member.

21. An image forming apparatus according to claim 19, wherein:
the adhesive image generating unit feeds the image support to the fixing device after transferring the adhesive toner image to the image support.

22. An image forming apparatus according to claim 20, wherein the adhesive image generating unit forms an adhesive toner image on the fixing member of the fixing device, and fixes the normal toner image and the adhesive toner image on the image support in a nip region, where the heating roll gets in contact with the pressing roll.

23. A post-process device comprising:
an adhesion device for bonding a recording medium repeelably through an adhesive toner image, the recording medium including an image structure formed on an image support and being folded while an image structure is on the inner side; wherein
an image structure comprises:
a normal toner image formed on the image support and comprising toner particles; and
an adhesive toner image formed on or around the normal toner image, serving as a repeelable adhesive layer and comprising toner particles,
the toner particles of the adhesive toner image have a glass transition point Tg in a range of from 30° C. to 50° C. and a melting point Tm in a range of from 70° C. to 110° C.,
the adhesion device includes a heating and conveyance member; and a pressing and conveyance member driving to rotate while being in contact with the heating and conveyance member and pressed by the heating conveyance member,
the folded recording medium is conveyed by the heating conveyance member and the pressing and conveyance member while nipped, and
a temperature of the adhesive toner image during nippig and conveying the recording medium is in a range of from the glass transition point Tg+10° C. to Tg+20° C. and not higher than the melting point Tm−10° C.

24. A post-process device according to claim 23, further comprising:
a folding device for folding the recording medium including the image structure while the image structure is on the inner side

25. An image forming apparatus according to claim 18, further comprising:
a post-process device comprising:
an adhesion device for bonding a recording medium repeelably through an adhesive toner image, the recording medium including an image structure formed on an image support and being folded while the image structure is on the inner side;
wherein the adhesion device includes a heating and conveyance member; and a pressing and conveyance member driving to rotate while being in contact with the heating and conveyance member and pressed by the heating conveyance member,
the folded recording medium is conveyed by the heating conveyance member and the pressing and conveyance member while nipped, and
a temperature of the adhesive toner image during nipping and conveying of the recording medium is in a range of from the glass transition point Tg+10° C. to Tg+20° C. and not higher than the melting point Tm−10° C.

26. The image forming apparatus according to claim 25, wherein the normal image generating unit and the adhesive image generating unit include a fixing device for fixing the normal toner image and the adhesive toner image on the image support, and the fixing device serves as an adhesion device.

27. The recording medium according to claim 16, wherein the image support has a light scattering layer containing a white pigment and a thermoplastic resin, and the thermoplastic resin of the light scattering layer has a viscosity not lower than 10⁴ Pa·s in fixing temperature.
